(19) United States
(12) Patent Application Publication
(10) Pub. No.: US 2016/0371983 A1
(43) Pub. Date: Dec. 22, 2016

(54) PARKING ASSIST SYSTEM AND METHOD

(71) Applicant: Garmin Switzerland GmbH, Schaffhausen (CH)

(72) Inventors: Daniel C. Ronning, Overland Park, KS (US); Robin G. Evans, Olathe, KS (US); Benjamin E. Jones, Olathe, KS (US)

(21) Appl. No.: 15/188,577

(22) Filed: Jun. 21, 2016

Related U.S. Application Data
(60) Provisional application No. 62/182,946, filed on Jun. 22, 2015.

(51) Int. Cl. G08G 1/16; G06K 9/00; B60Q 1/00

(52) U.S. Cl. CPC G08G 1/168; B60Q 1/00; G06K 9/00812

(57) ABSTRACT

Techniques are provided for implementing a system that can assist a user with parking a vehicle in a desired location using a portable device such as a smartphone or a personal navigation device. Implementations capture an image of the vehicle's surroundings when it is in the position the user wishes to parking (for example, when it is pulled far enough into a garage to allow the garage door to close). Subsequently, when the user wishes to park in that location again, one or more comparison images are captured in real time and compared to the reference image. When the current comparison image agrees with the reference image, the vehicle is in the correct position.

### RELATED APPLICATIONS

The present application claims priority benefit under 35 U.S.C. §119(e), with regard to all common subject matter, of U.S. Provisional Application Ser. No. 62/182,946, filed Jun. 22, 2015, and titled “PARKING ASSIST FEATURE,” which is herein incorporated by reference in its entirety.

### BACKGROUND

Drivers often park in certain places repeatedly, such as home carports or garages. Some drivers may seek guidance for parking in the ideal location so that they do not obstruct the garage door or have a collision with difficult to view objects like steps that are below the hood of the vehicle or in a blind spot. Visual cues may be used such as trying to remember the relative distance and/or position of a fixture near the ideal spot or a hanging object that makes contact with a portion of the vehicle when it is in the ideal position. These methods may be unreliable or unsightly. Other methods may require the use of expensive sensors that must be integrated into a vehicle during manufacture.

### SUMMARY

Embodiments of the present technology relate generally to aftermarket navigation systems used in a vehicle. In particular, in a first embodiment, the invention includes a system for assisting a user in parking a vehicle, comprising a camera, a location determining component, a display, a processor, and one or more computer-readable media storing computer-executable instructions that, when executed by the processor, assist the user in parking the vehicle by capturing, using the camera, a registration image when the vehicle is in a first parking location, capturing, using the location determining component, a geographic location of the system when the vehicle is in the first parking location, subsequently determining, using the location determining component, that the vehicle is within a predetermined distance of the geographic location, in response to determining that the vehicle is within the predetermined distance of the geographic location, causing the system to enter a parking assist mode comprising capturing, using the camera, a comparison image, determining a proximity of the vehicle to the first parking location by comparing the comparison image to the registration image, and displaying, on the display, a visual representation of the proximity.

In additional embodiments, the invention includes a system for assisting a user in parking a vehicle in a first parking location, comprising a camera, a location determining component, a display, a processor and one or more computer-readable media storing computer-executable instructions that, when executed by the processor, assist the user in parking the vehicle by determining, using the location determining component, that the vehicle is within a predetermined distance of the first parking location determining, based on one of a time since sunrise and a time until sunset, a registration image of a plurality of registration images, capturing, using the camera, a comparison image, determining a proximity of the vehicle to the first parking location by measuring convergence of a plurality of features common to the comparison image and the registration image, displaying a visual representation of the proximity of the vehicle to the first parking location on the display.

In additional embodiments, the invention includes a method of assisting a user in parking a vehicle, comprising capturing, using a camera associated with a portable device in the vehicle, a registration image when the vehicle is in a first parking location, capturing, using a location determining component of the portable device in the vehicle, a geographic location of the portable device when the vehicle is in the first parking location, subsequently determining, using the location determining component of the portable device in the vehicle, that the vehicle is within a predetermined distance of the geographic location, in response to determining that the vehicle is within the predetermined distance of the geographic location, causing the portable device to enter a parking assist mode comprising capturing, using the camera associated with the portable device, a comparison image, determining a proximity of the vehicle to the first parking location by comparing the comparison image to the registration image, and displaying, on a display associated with the portable device, a visual representation of the proximity.

### BRIEF DESCRIPTION OF THE DRAWING FIGURES

The figures described below depict various aspects of the system and methods disclosed herein. It should be understood that each figure depicts an embodiment of a particular aspect of the disclosed system and methods, and that each of the figures is intended to accord with a possible embodiment thereof. Further, whenever possible, the following description refers to the reference numerals included in the following figures, in which features depicted in multiple figures are designated with consistent reference numerals.

FIG. 1 is an illustration of a block diagram of an exemplary navigation system 100 in accordance with an embodiment of the present disclosure;

FIGS. 2A-2C are schematic illustration examples of user interface screens 200 used to implement a navigation device as a driving recorder, according to an embodiment;

FIGS. 3A-3B are schematic illustration examples of user interface screens 300 used in conjunction with a navigation system, according to an embodiment;

FIGS. 4A-4D are schematic illustration examples of user interface screens 400 used to implement a navigation device in conjunction with a lane departure notification system, according to an embodiment;

FIG. 5A is a schematic illustration example of a one-way street 500 showing road lane line markings, according to an embodiment;

FIG. 5B is a schematic illustration example of two-lane undivided highway 550 showing road lane line markings, according to an embodiment;

FIG. 6 illustrates a method flow 600, according to an embodiment;

FIGS. 7A-7C are schematic illustration examples of user interface screens 700 used to implement a navigation device in conjunction with a collision notification system, according to an embodiment;

FIG. 8A is a schematic illustration example 800 of the rear of a vehicle within live video captured during the daytime, according to an embodiment;

FIG. 8B is a schematic illustration example 850 of the rear of a vehicle within live video captured during the nighttime, according to an embodiment; and

FIG. 9 illustrates a method flow 900, according to an embodiment;

FIG. 10 illustrates the detection and correspondence of features of a reference image and a comparison image;

FIG. 11A illustrates the determination of the convergence of the corresponding features of the reference image and a comparison image and a visual representation of the proximity;

FIG. 11 illustrates an alternate view of the determination of the convergence point for the features of the reference image and a comparison image;

FIG. 12 illustrates an alternate visual representation of the proximity;

FIG. 13 illustrates a method flow 1300, according to an embodiment; and

FIG. 14 illustrates a method flow 1400, according to an embodiment.

### DETAILED DESCRIPTION

The following text sets forth a detailed description of numerous different embodiments. However, it should be understood that the detailed description is to be construed as exemplary only and does not describe every possible embodiment since describing every possible embodiment would be impractical. In light of the teachings and disclosures herein, numerous alternative embodiments may be implemented.

It should be understood that, unless a term is expressly defined in this patent application using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application.

Embodiments are disclosed describing a driving recorder. The driving recorder may be integrated as part of an aftermarket navigational system, thereby consolidating a driving recorder and a navigational system into a single aftermarket device. The device may include one or more sensors and/or cameras positioned to automatically record video in front of the vehicle, which may be recorded continuously, in a memory buffer, and/or manually. Embodiments include the device utilizing sensory input to detect triggering events (e.g., an accident) that result in the start of video recording and/or the transfer of buffered video to a more permanent form of memory, such as a removable memory card, for example.

Other embodiments are disclosed that describe a lane departure notification system. The lane departure notification system may utilize cartographic data stored as part of the navigational system to identify a type of road (road type) upon which the vehicle is traveling. The type of road information may indicate the direction of traffic (e.g., one way or two way) and the number of lanes for each direction of traffic for each road. For instance, a processor may use the type of road information to determine that the road being traveled is a two-way road with two lanes for each direction of traffic. When a vehicle lane departure is detected, the lane departure notification system may selectively issue an alert when the road type indicates that the vehicle may be veering off into oncoming traffic, but otherwise suppress the alert. For instance, the lane departure notification system may suppress the alert if the vehicle is determined to be traveling on a two-way road with two lanes for each direction and the vehicle is crossing from the right lane to the left lane while maintaining the direction of movement. The first alert may be suppressed when the vehicle is determined to cross the dashed road lane line and enter a different lane in the same direction of travel. The lane departure notification system may also suppress the alert if the vehicle is determined to be traveling on a one-way road with one or more lanes for the permitted direction of travel and the vehicle is crossing from one lane to another lane while maintaining the direction of movement.

In still other embodiments, a collision notification system is described. The collision notification system may utilize captured live video data (e.g., mounted as a dash cam) and determine whether the rear of a vehicle is present in the live video data. By performing an analysis of the live video data, portions of one or more vehicles (e.g., the rear of a vehicle) within the live video data may be identified. Once the collision prevention system detects the rear of at least one vehicle in the video, a mathematical algorithm may be applied to the live video data to determine a following distance, and an alert may be issued if the estimated distance is less than a threshold recommended following distance (RFD). In embodiments, a processor may determine an estimated distance from a navigation device (and the vehicle within which the navigation device 102 is located) to a vehicle within the live video data and an estimated time to impact for the vehicle within which the navigation device 102 is located to the identified vehicle determined to be present in the live video data. When a plurality of vehicles are determined to be present in the live video data, the collision prevention system may identify a single vehicle of interest and determine a following distance to that vehicle.

Because the collision notification system may be integrated with a navigational system, the time of day and geographic data may be leveraged to determine whether the video is being captured during the daytime or nighttime. The collision notification system may classify the video data using different training data models for videos captured during the daytime and nighttime to better identify the rear of a vehicle.

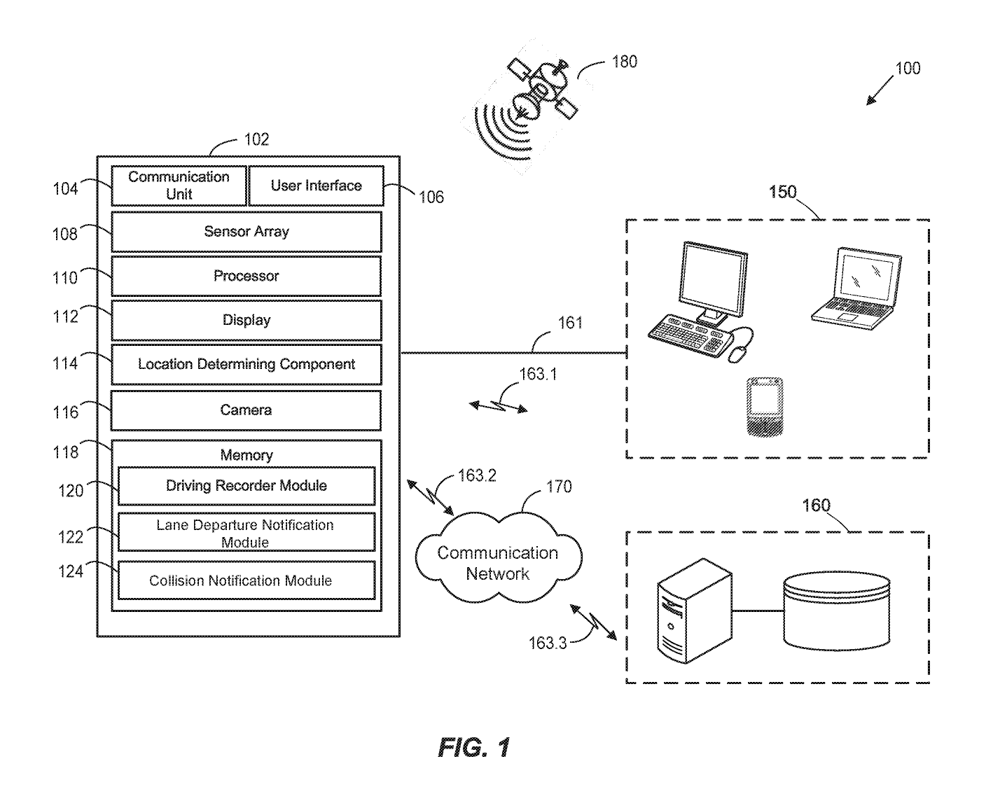

FIG. 1 is an illustration of a block diagram of an exemplary navigation system 100 in accordance with an embodiment of the present disclosure.

In some embodiments, navigation device 102 may act as a standalone device and not require communications with external computing devices 150 or 160. But in other embodiments, which are further discussed below, navigation device 102 may communicate with and/or work in conjunction with one or more of external computing devices 150 and/or 160.

Navigation device 102, one or more external computing devices 150, and/or one or more external computing devices 160 may be configured to communicate with one another using any suitable number of communication networks and wired and/or wireless links (e.g., communication network 170, wired link 161, and/or wireless links 163.1-163.3) in conjunction with any suitable number and type of communication protocols.

In an embodiment, one or more of external computing devices 150 and/or external computing devices 160 may include any suitable number and/or type of computing devices configured to communicate with and/or exchange data with navigation device 102. For example, one or more of external computing devices 150 may be implemented as a mobile computing device (e.g., smartphone, tablet, laptop, phablet, netbook, notebook, pager, personal digital assistant (PDA), wearable computing device, smart glasses, a smart watch or a bracelet, etc.), or any other suitable type of computing device capable of wired and/or wireless communication (e.g., a desktop computer), while one or more of external computing devices 160 may be implemented as one or more traffic data services, web servers, databases, etc.

In an embodiment, navigation device 102 may communicate with one or more of external computing devices 150 and/or external computing devices 160 to send data to and/or to receive data from external computing devices 150 and/or external computing devices 160. For example, navigation device 102 may communicate with one or more external computing devices 150 to receive updated cartographic data. To provide another example, navigation device 102 may communicate with one or more external computing devices 160 to receive traffic data and/or to send data collected, measured, and/or generated by navigation device 102 to external computing devices 160 (e.g., road lane data, road type data, etc., as further discussed below).

Communication network 170 may include any suitable number of nodes, additional wired and/or wireless networks, etc., in various embodiments. For example, in an embodiment, communication network 170 may be implemented with any suitable number of base stations, landline connections, internet service provider (ISP) backbone connections, satellite links, public switched telephone network (PSTN) connections, local area networks (LANs), metropolitan area networks (MANs), wide area networks (WANs), any suitable combination of local and/or external network connections, etc. To provide further examples, communication network 170 may include wired telephone and/or cable hardware, satellite, cellular phone communication networks, etc. In various embodiments, communication network 170 may provide navigation device 102 with connectivity to network services, such as Internet services, for example.

Communication network 170 may be configured to support communications between navigation device 102 and external computing devices 160 in accordance with any suitable number and/or type of wired and/or wireless communication protocols. Examples of suitable communication protocols may include personal area network (PAN) communication protocols (e.g., BLUETOOTH), Wi-Fi communication protocols, radio frequency identification (RFID) and/or a near field communication (NFC) protocols, cellular communication protocols, Internet communication protocols (e.g., Transmission Control Protocol (TCP) and Internet Protocol (IP)), etc.

In another embodiment, navigation device 102 need not communicate with one or more of external computing devices 150 and/or 160. For example, as will be further discussed below, navigation device 102 may operate as a standalone navigation device that is installed in a vehicle to perform various functions.

Navigation device 102 may be implemented as any suitable type of portable and/or mobile device configured to function as a driving recorder, lane departure notification system, and/or collision notification system. Embodiments include navigation device 102 implementing any suitable combination of these functions. Navigation device 102 may implement some of these functions without implementing others.

In an embodiment, navigation device 102 may include a communication unit 104, a user interface 106, a sensor array 108, one or more processors 110, a display 112, a location determining component 114, a camera 116, and a memory 118. Navigation device 102 may include additional elements such as, for example, power sources, memory controllers, memory card slots, ports, interconnects, etc., which are not described herein for purposes of brevity.

Communication unit 104 may be configured to support any suitable number and/or type of communication protocols to facilitate communications between navigation device 102 and one or more of external computing devices 150 and/or external computing devices 160. Communication unit 104 may be configured to receive any suitable type of information via one or more of external computing devices 150 and/or external computing devices 160. Communication unit 104 may be implemented with any suitable combination of hardware and/or software to facilitate this functionality. For example, communication unit 104 may be implemented with any number of wired and/or wireless transceivers, ports, connectors, antennas, etc.

Communication unit 104 may be configured to facilitate communications with various external computing devices 150 and/or external computing devices 160 using different types of communication protocols. For example, communication unit 104 may communicate with a mobile computing device via a wireless Bluetooth communication protocol (e.g., via wireless link 163.1) and with a laptop or a personal computer via a wired universal serial bus (USB) protocol (e.g., via wired link 161). To provide another example, communication unit 104 may communicate with a traffic aggregation service via network 170 using a wireless cellular protocol (e.g., via links 163.1-163.3). Communication unit 104 may be configured to support simultaneous or separate communications between two or more of external computing devices 150 and/or external computing devices 160.

User interface 106 may be configured to facilitate user interaction with navigation device 102 and/or to provide feedback to a user. In an embodiment, a user may interact with user interface 106 to change various modes of operation, to initiate certain functions, to modify settings, set options, etc., which are further discussed below.

For example, user interface 106 may include a user-input device such as an interactive portion of display 112 (e.g., a “soft” keyboard, buttons, etc.) displayed on display 112), physical buttons integrated as part of navigation device 102 that may have dedicated and/or multi-purpose functionality, etc. To provide another example, user interface 106 may cause visual alerts to be displayed via display 112 and/or audible alerts to be sounded. Audible alerts may be sounded using any suitable device, such as a buzzer, speaker, etc., which are not shown in FIG. 1 for purposes of brevity.

Sensor array 108 may be implemented as any suitable number and/or type of sensors configured to measure, monitor, and/or quantify one or more characteristics of navigation device 102's environment as sensor data metrics. For example, sensor array 108 may measure the acceleration of navigation device 102 in one or more directions and, as a result, measure the acceleration of the vehicle in which navigation device 102 is mounted. To provide another example, sensor array 108 may measure other sensor data metrics such as light intensity, magnetic field direction and intensity (e.g., to display a compass direction), etc.

Sensor array 108 may be advantageously mounted or otherwise positioned within navigation device 102 to facilitate these functions. Sensor array 108 may be configured to sample sensor data metrics and/or to generate sensor data metrics continuously or in accordance with any suitable recurring schedule, such as, for example, on the order of several milliseconds (e.g., 10 ms, 100 ms, etc.), once per every second, once per every 5 seconds, once per every 10 seconds, once per every 30 seconds, once per minute, etc.

Examples of suitable sensor types implemented by sensor array 108 may include one or more accelerometers, gyroscopes, perspiration detectors, compasses, speedometers, magnetometers, barometers, thermometers, proximity sensors, light sensors (e.g., light intensity detectors), photodetectors, photoresistors, photodiodes, Hall Effect sensors, electromagnetic radiation sensors (e.g., infrared and/or ultraviolet radiation sensors), ultrasonic and/or infrared range detectors, humistors, hygrometers, altimeters, biometrics sensors (e.g., heart rate monitors, blood pressure monitors, skin temperature monitors), microphones, etc.

Display 112 may be implemented as any suitable type of display configured to facilitate user interaction, such as a capacitive touch screen display, a resistive touch screen display, etc. In various aspects, display 112 may be configured to work in conjunction with user interface 106 and/or processor 110 to detect user inputs upon a user selecting a displayed interactive icon or other graphic, to identify user selections of objects displayed via display 112, etc.

Location determining component 114 may be configured to utilize any suitable communications protocol to facilitate determining a geographic location of navigation device 102. For example, location determining component 114 may be configured to communicate with one or more satellites 180 and/or wireless transmitters in accordance with a Global Navigation Satellite System (GNSS) protocol, to determine a geographic location of navigation device 102, and to generate geographic location data. Wireless transmitters are not illustrated in FIG. 1, but may include, for example, one or more base stations implemented as part of communication network 170.

For example, location determining component 114 may be configured to utilize “Assisted Global Positioning System” (A-GPS), by receiving communications from a combination of base stations (that may be incorporated as part of communication network 170) and/or from satellites 180. Examples of suitable global positioning communications protocol may include Global Positioning System (GPS), the GLONASS system operated by the Russian government, the Galileo system operated by the European Union, the BeiDou system operated by the Chinese government, etc.

Camera 116 may be configured to capture pictures and/or videos and to generate live video data. Camera 116 may include any suitable combination of hardware and/or software such as image sensors, optical stabilizers, image buffers, frame buffers, charge-coupled devices (CCDs), complementary metal oxide semiconductor (CMOS) devices, etc., to facilitate this functionality.

In an embodiment, camera 116 may be housed within or otherwise integrated as part of navigation device 102. Camera 116 may be strategically mounted on navigation device 102 such that, when navigation device 102 is mounted in a vehicle, camera 116 may capture live video and generate live video data of the road and/or other objects in front of the vehicle in which navigation device 102 is mounted. For example, camera 116 may be mounted on a side of navigation device 102 that is opposite of display 112, allowing a user to view display 112 while camera 116 captures live video and generated live video data.

Processor 110 may be implemented as any suitable type and/or number of processors, such as a host processor of navigation device 102, for example. To provide additional examples, processor 110 may be implemented as an application specific integrated circuit (ASIC), an embedded processor, a central processing unit (CPU) associated with navigation device 102, a graphical processing unit (GPU), etc.

Processor 110 may be configured to communicate with one or more of communication unit 104, user interface 106, sensor array 108, display 112, location determining component 114, camera 116, and memory 118 via one or more wired and/or wireless interconnections, such as any suitable number of data and/or address buses, for example. These interconnections are not shown in FIG. 1 for purposes of brevity.

Processor 110 may be configured to operate in conjunction with one or more of communication unit 104, user interface 106, sensor array 108, display 112, location determining component 114, camera 116, and memory 118 to process and/or analyze data, to store data to memory 118, to retrieve data from memory 118, to display information on display 110, to receive, process, and/or interpret sensor data metrics from sensor array 108, to process user interactions via user interface 106, to receive and/or analyze live video data captured via camera 116, to determine whether a lane departure notification and/or vehicle proximity warning should be issued, to receive data from and/or send data to one or more of external computing devices 150 and/or 160, etc.

In accordance with various embodiments, memory 118 may be a computer-readable non-transitory storage device that may include any suitable combination of volatile memory (e.g., a random access memory (RAM) or non-volatile memory (e.g., battery-backed RAM, FLASH, etc.). Memory 118 may be configured to store instructions executable on processor 110, such as the various memory modules illustrated in FIG. 1 and further discussed below, for example. These instructions may include machine-readable instructions that, when executed by processor 110, cause processor 110 to perform various acts as described herein. Memory 118 may also be configured to store any other suitable data used in conjunction with navigation device 102, such as data received from one or more of external computing devices 150 and/or 160 via communication unit 104, sensor data metrics from sensor array 108 and information processed by processor 110, buffered live video data, cartographic data, data indicative of sunrise and sunset times by geographic location, etc.

Memory 118 may include a first portion implemented as integrated, non-removable memory and a second portion implemented as a removable storage device, such as a removable memory card. For example, memory 118 may include a SD card that is removable from navigation device 102 and a flash memory that is not removable from navigation device 102. Data may be transferred from a first portion of memory 118 (e.g., buffered live video data) to a second portion of memory 118, thereby allowing a user to remove a portion of memory 118 to access viewing data stored thereon on another device.

Driving recorder module 120 is a region of memory 118 configured to store instructions that, when executed by processor 106, cause processor 110 to perform various acts in accordance with applicable embodiments as described herein.

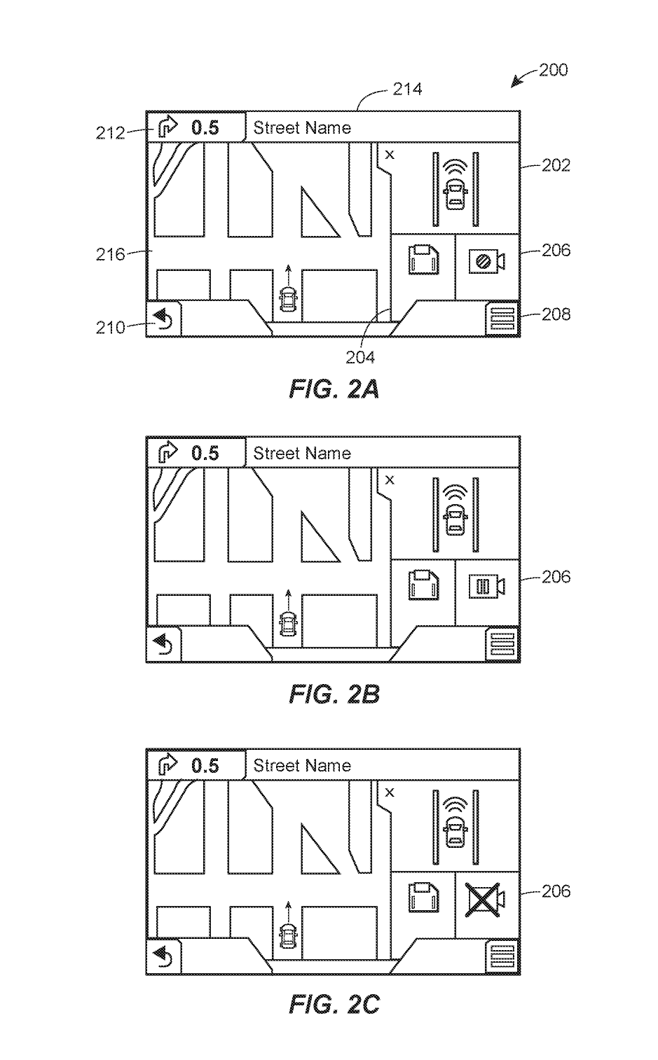

In an embodiment, driving recorder module 120 includes instructions that, when executed by processor 110, cause processor 110 to record live video data generated via camera 116, to determine a recording and/or storage trigger, to store the live video data to memory 118, and/or to play stored live video data on display 112. These functions are further discussed below with respect to FIGS. 2A-2C.

In various embodiments, processor 110 may store live video data generated via camera 116 in various ways. For example, in one embodiment, driving recorder module 120 may include instructions that, when executed by processor 110, cause processor 110 to continuously store live video data to memory 118. In accordance with such embodiments, the recording of the live video data may be triggered by the passage of a certain period of time after navigation device 102 is powered on, when threshold movement is exceeded (e.g., via sensor data metrics generated via sensor array 108), when a threshold speed is exceeded, etc.

Further in accordance with continuous recording embodiments, the live video data may be overwritten once a portion of memory 118 allocated to store live video data has been filled to a threshold level (or a threshold amount of memory space is remaining), which may occur over the period of several hours, several days, etc., based upon the memory capacity of memory 118. Before being overwritten, processor 110 may cause display 112 to display an indication accordingly. In this way, a user may save the live video feed before it is overwritten if desired.

In another embodiment, driving recorder module 120 may include instructions that, when executed by processor 110, cause processor 110 to store live video data to memory 118 upon receipt of a trigger generated via user interface 106. For example, a user may manually select a recording option via a suitable graphic, icon, label, etc., displayed on display 112.

In yet other embodiments, driving recorder module 120 may include instructions that, when executed by processor 110, cause processor 110 to store live video data to memory 118 in a rolling buffer, which is continuously updated as new live video data is received until one or more storage triggers are detected. The rolling buffer size may be any suitable capacity to facilitate recording of live video for a duration of time allowing an event associated with the storage trigger to be captured, such as 30 seconds, 1 minute, 2 minutes, 5 minutes, 10 minutes, etc. A storage trigger may be based upon one or more sensor data metrics that are identified with a vehicular accident or other noteworthy event such that, when satisfied, a portion of the buffered live video data beginning shortly before the noteworthy event, such as 30 seconds, 1 minute, or 2 minutes, etc. prior to the noteworthy event, is moved to another portion of memory 118, such as a removable SD card. Once a noteworthy event occurs, processor 110 may also store in memory 118 a portion of the buffered live video data captured for a period of time, such as 5 minutes or 10 minutes, after the noteworthy event.

To provide an illustrative example, processor 110 may compare accelerometer data metrics to predetermined and/or known data profiles associated with the deceleration of a vehicle during a crash, a rollover, a sudden stop, etc. When the accelerometer data metrics are within a threshold value of the data profiles, processor 110 may determine that the storage trigger condition has been satisfied. Once a storage trigger is detected, the buffering of new live video data may momentarily stop and the buffer contents transferred, thereby preserving live video data of the event responsible for the generation of the storage trigger before it is flushed from the buffer, or continue buffering new live video data to capture additional footage after a noteworthy event.

It should be understood that processor 110 may account for variations in directions of traffic flow and lane types used in various countries. For instance, processor 110 may determine that navigation device 102 (and the vehicle within which the navigation device 102 is located) is located in a country where traffic flows on the right side of each road and use that determination when providing lane departure notification functionality and collision notification functionality.

Lane departure notification module 122 is a region of memory 118 configured to store instructions, that when executed by processor 106, cause processor 110 to perform various acts in accordance with applicable embodiments as described herein.

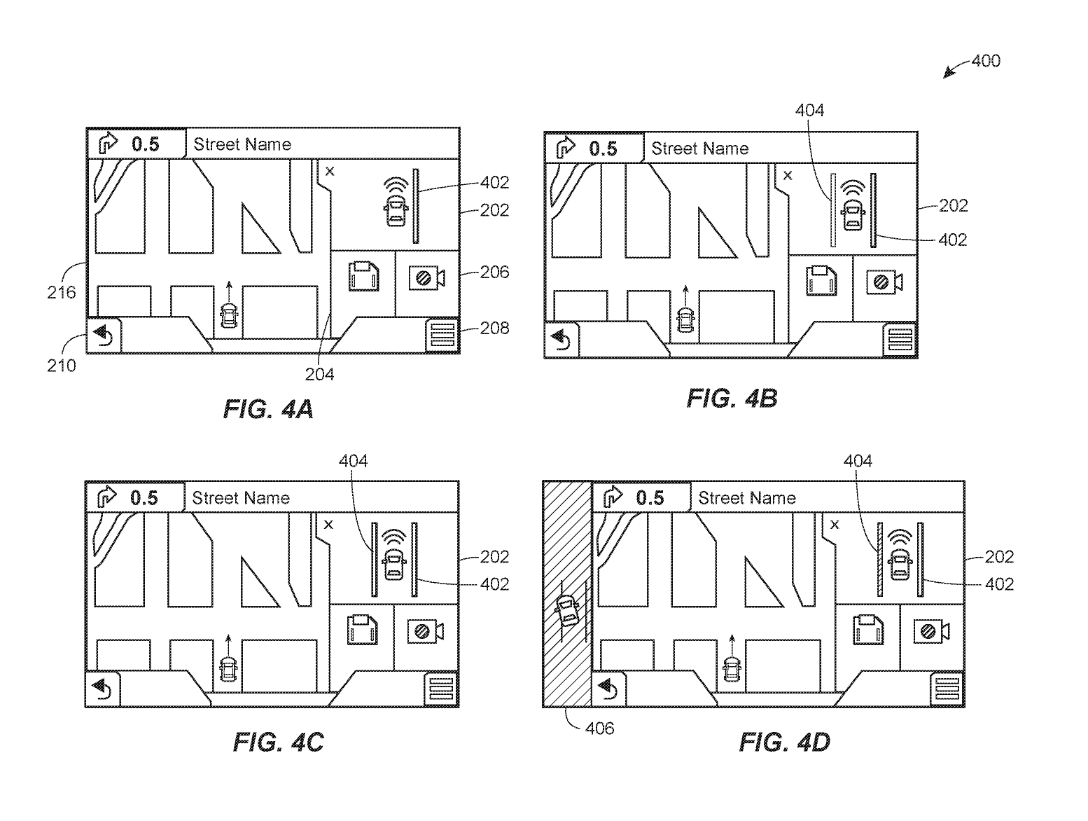

In an embodiment, lane departure notification module 122 includes instructions that, when executed by processor 110, cause processor 110 to analyze live video data generated via camera 116, to determine if the vehicle in which navigation device 102 is mounted has crossed a road lane line, to identify the crossed road lane line as a dashed or a solid road lane line, to reference cartographic data to determine a road type on which the vehicle is traveling, and to cause an alert to be issued based upon the type of the crossed road lane line in conjunction with the road type. These functions are further discussed below with respect to FIGS. 4A-4D.

In an embodiment, processor 110 may analyze the live video data in accordance with any suitable number and/or type of machine vision algorithms to detect road lane lines adjacent to the vehicle and to determine whether the road lane lines are dashed or solid road lane lines. For example, processor 110 may analyze the live video data using any suitable edge detection techniques, such as a Canny edge detection technique or other suitable types of search-based or zero-crossing based techniques that analyze variations in contrast, for example. As a result of the applied edge-detection, processor 110 may identify line segments within the live video data.

Once the line segments are identified via edge detection (or other suitable techniques), embodiments include processor 110 identifying a vanishing point within the live video data based upon a convergence of identified line segments having a particular length longer than other identified line segments, which may be represented by exceeding a number of pixels within the live video data, for example. For example, solid and dashed road lane lines may have pixel dimensions of a threshold size that is greater than other identified line segments within the live video data.

After identifying the vanishing point within the live video data, embodiments include processor 110 compensating for the position of navigation device 102 within the vehicle based upon the identified vanishing point. That is, navigation device 102 may be mounted on the left, center, or right of a dashboard within a vehicle. Without knowledge of the vanishing point, it is difficult to ascertain a reference point to identify road lane lines with respect to the vehicle, as a left-mounted navigation device may record live video showing a left line closer than it actually is. But with knowledge of the vanishing point within the live video data, processor 110 may establish a reference point by mapping the vanishing point to the current lane in which the vehicle is traveling, thereby compensating for image skewing and/or various positions of navigation device 102.

In some embodiments, a user may further assist this compensation process by specifying the mounting position of navigation device 102 on the dashboard (e.g., as left, center, or right) via user interface 106. In accordance with such embodiments, processor 110 may utilize this selection to further compensate for the position of navigation device 102 to identify the road lane lines.

For example, when a left-mounting configuration is entered by a user, processor 110 may adjust for the road lane lines to the right and left of the vehicle appearing closer to the left within the live video data. In an embodiment, processor 110 may apply left, center, and right compensating profiles whereby this offset is accounted for via a predetermined offset number of pixels, the live video data shifting the road lane lines by a preset amount based upon the profile selection when the images are processed, etc.

Using the vanishing point as a reference point in this way, embodiments include processor 110 identifying lines adjacent to those used to establish the vanishing point as the road lane lines to the left and right of the vehicle. In other words, a “reference” lane may be determined using the lines adjacent to the vehicle to identify a current lane in which the vehicle is traveling. Based upon this reference lane, processor 110 may identify the shape of other nearby parallel road lane lines and the overall shape of the road. Using the movement of the identified road lanes with respect to the established vanishing point, a determination may also be made as to whether the vehicle, in which the navigation device 102 is located, may cross or has already crossed one of the adjacent road lane lines and thereby exiting the reference lane. When the vehicle moves into an adjacent road lane, embodiments include processor 110 repeating this process to identify a new reference lane.

In an embodiment, processor 110 may execute instructions stored in lane departure notification module 122 to categorize the identified road lane lines within the live video data as dashed and solid lines. This may be performed, for example, via a comparison of the number of occupied pixels with respect to the height and/or width of the captured live video data. Identified lane lines occupying a greater pixel length are classified as solid lane lines, while identified lane lines occupying less pixels are classified as dashed lane lines. In an embodiment, any suitable threshold may be selected as the number of pixel to facilitate the differentiation between solid and dashed lane lines.

In an embodiment, navigation device 102 may provide navigational guidance. Therefore, navigational device 102 may store cartographic data in memory 118. This cartographic data may include, for example, road types (e.g., one-way, highway, freeway, tollway, divided highway, etc.) an indication of the number of lanes, map data used in conjunction with the geographic location data and provide route guidance, etc.

In an embodiment, processor 110 may reference the cartographic data to the geographic location data to determine a road type and/or characteristics of the road upon which the vehicle is currently traveling. Processor 110 may execute instructions stored in lane departure notification module 122 to condition the issuance of a lane departure alert by leveraging this cartographic data.

That is, if processor 110 detects that a vehicle has crossed an adjacent solid road lane line, processor may cause an alert to be issued. But if processor 110 detects that the vehicle has crossed an adjacent road lane line that is a dashed line, the alert may not be necessary as the vehicle may be changing lanes, and the driver is fully aware of the lane change. In an embodiment, when processor 110 detects that the vehicle has crossed a dashed road lane line, processor 110 may conditionally issue the alert when the vehicle is crossing into oncoming traffic, but otherwise suppress the alert.

To provide an illustrative example, processor 110 may detect that the vehicle has crossed an adjacent dashed road lane line but, by referencing the cartographic data to the geographic location data, determine that the road is a one-way street and thus suppress the alert.

To provide another illustrative example, processor 110 may detect that the vehicle has crossed an adjacent dashed road lane line to the left of the vehicle. Again, by referencing the cartographic data to the geographic location data, processor 110 may determine that the road is a two-way highway and that crossing the dashed lane in this case would result in the vehicle crossing into oncoming traffic. In this scenario, processor 110 may cause the alert to be appropriately issued.

In this way, the cartographic data may be leveraged to issue a lane departure alert only when the vehicle is crossing into oncoming traffic, and otherwise suppress the alert. This advantageously allows for a navigation device 102, when implemented as a standalone device, to more accurately discriminate between intentional and unintentional lane changes without access to vehicle sensors.

In various embodiments, processor 110 may utilize any suitable number and/or type of road lane line characteristics to determine whether to issue a lane departure notification alert, which may or may not utilize the cartographic data. For example, embodiments include the identification of road lane line colors as yellow or white. Processor 110 may issue an alert when the vehicle crosses a yellow dashed line but suppress the alert when the vehicle crosses a white dashed line.

Collision notification module 124 is a region of memory 118 configured to store instructions, that when executed by processor 110, cause processor 110 to perform various acts in accordance with applicable embodiments as described herein.

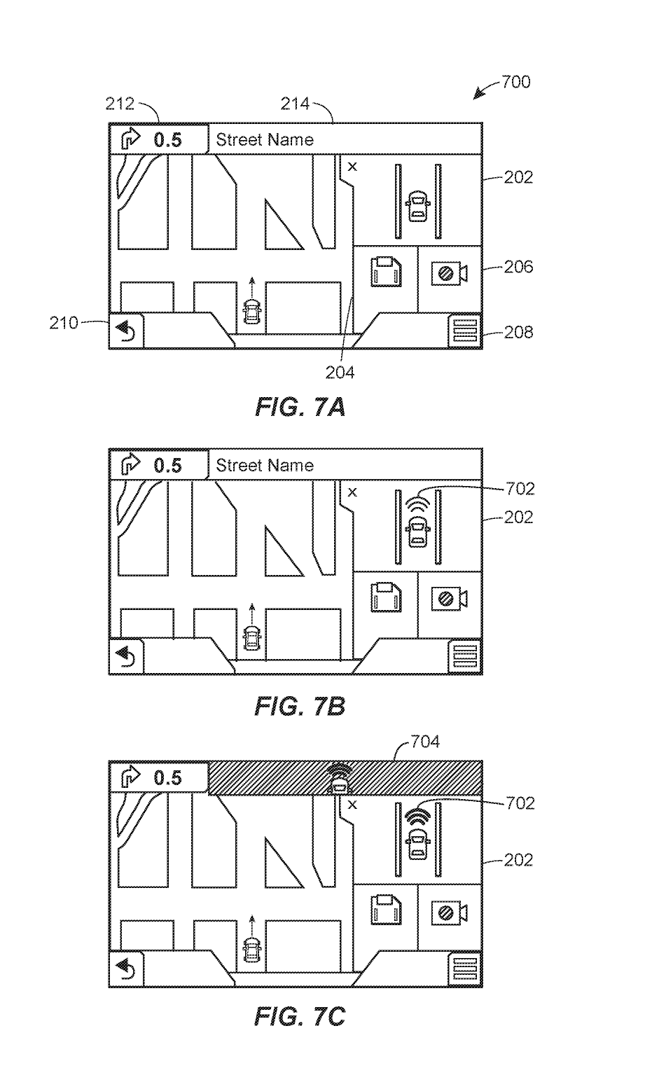

In embodiments, collision notification module 124 includes instructions that, when executed by processor 110, cause processor 110 to analyze live video data generated via camera 116, to classify the live video data according to either a daytime training model or a nighttime training model, to identify a portion of at least one vehicle within the live video data, to calculate an estimated distance from the navigation device 102 (and the vehicle within which the navigation device 102 is located) to the identified vehicle determined to be present in the live video data, and to cause an alert to be issued when an estimated distance from the navigation device 102 to the identified vehicle is less than a threshold RFD. These functions are further discussed below with respect to FIGS. 7A-7C.

In some embodiments, collision notification module 124 includes instructions that, when executed by processor 110, cause processor 110 to analyze live video data generated via camera 116, to classify the live video data according to either a daytime training model or a nighttime training model, to identify a portion of at least one vehicle within the live video data, to calculate an estimated time to impact for the vehicle within which the navigation device 102 is located to the identified vehicle determined to be present in the live video data, and to cause an alert to be issued when an estimated time to impact to the identified vehicle is less than a threshold RFD.

In embodiments, memory 118 may be configured to store various training data models. These training data models may include, for example, a daytime data training model corresponding to one range of video data metrics that indicate that a portion of a vehicle is contained within the live video data during the daytime, and a nighttime training data model corresponding to another range of video data metrics that indicate the portion of a vehicle is contained within the live video data during the nighttime. These metrics may include any metrics suitable for the classification of live video data images by comparison to these training data models, such as brightness, groupings of pixels forming specific patterns or shapes, pixel coloration, edges detected within the live video data, contrasting portions within the live video data, histograms, image statistics (e.g., mean, standard deviation, image moments, etc.), filters, image gradient, etc.

In an embodiment, memory 118 may store daytime training data models including video data from several sampled images that correspond to a portion of a vehicle (e.g., the rear portion) being in front of the vehicle in which navigation device 102 is mounted. For example, the training data models may include many (more than 1000) image samples of various vehicle rear ends, which may include various vehicle models, colors, shapes, angles, etc. In an embodiment, the classification process may include processor 110 executing instructions stored in collision notification module 124 to compare live video data to several of the training data models to attempt to identify whether a portion of a vehicle (e.g., the rear portion) is contained within the live video data.

Based on the output from the executed classification algorithm on the live video data, a determination may be made based upon the characteristics utilized by that particular classification algorithm. Processor 110 may use any suitable type and/or number of classification algorithms to make this determination. For example, collision notification module 124 may store instructions that, when executed by processor 110, cause processor 110 to execute a linear classifier algorithm, a support vector machine algorithm, a quadratic classifier algorithm, a kernel estimation algorithm, a boosting meta-algorithm, a decision tree algorithm, a neural network algorithm, a learning vector quantization algorithm, etc.

Although embodiments include any suitable classification algorithm being executed to attempt to identify the presence of a portion of a vehicle within the live video data, environmental conditions such as lighting may impact the outcome. In an embodiment, daytime training data models and nighttime training data models may have lighting features that differ from one another, as each set of training data models include vehicle images taken during the daytime and nighttime, respectively.

For example, the presence of taillights may be prominent in nighttime vehicle images while being absent in daytime images. To provide another example, the contrast between edges in daytime vehicle images may be more prominent those of in nighttime vehicle images. Therefore, the selection of which set of model training data used in the classification process may impact the accuracy and efficiency of identifying a portion of the vehicle within the live video data. Using daytime training data models as a basis for the classification of live video data captured during the nighttime may result in a portion of the vehicle not being identified within the live video data, a false identification, etc. Similarly, using nighttime training data models as a basis for the classification of live video data captured during the daytime may not provide accurate results.

Therefore, embodiments include processor 110 executing instructions stored in collision notification module 124 to perform classification on live video data using daytime training data models when the live video data is captured during the daytime, while using nighttime training data models when the live video data is captured during the nighttime.

Embodiments include processor 110 determining whether the live video data is captured during the “daytime” or “nighttime” using any suitable number and/or type of techniques. For example, location determining component 114 may receive Global Navigation Satellite System (GNSS) data and generate geographic location data indicative of a geographic location of the navigation device, which may be utilized by processor 110 to perform geographic location calculations. Using this signal, processor 110 may ascertain the time of day, as GNSS systems require time synchronization. Further in accordance with such an embodiment, processor 110 may utilize the geographic location data (e.g., latitude and longitude coordinates) to calculate a sunrise and sunset time corresponding to the location of navigation device 102 when the live video data was captured.

For example, sunrise and sunset times for ranges of latitude and longitude coordinates may be stored in any suitable portion of memory 118. Processor 110 may determine the sunrise and sunset time by referencing the geographic location data to the ranges of latitude and longitude coordinates stored in memory 118. Processor 110 may then compare the time of day to the sunset/sunrise times to make a more accurate determination of whether it is daytime or nighttime when the live video data is being captured.

To provide another example, the daytime/nighttime determination may be performed using sensory data generated by sensor array 108 (e.g., via photocells), a brightness and/or contrast analysis of the live video data, an ISO setting used by sensor array 108, an ISO data setting used by camera 116 (e.g., an automatically changing ISO setting will reduce when brighter images are captured), etc.

Regardless of the training data models that are used in the classification process, once the portion of at least one vehicle is identified in the live video data, embodiments include processor 110 executing instructions stored in collision notification system 124 to analyze the live video data and determine an estimated distance between navigation device 102 (and the vehicle within which the navigation device 102 is located) and the vehicle captured in the live video data. Embodiments include processor 110 calculating or estimating this distance using any suitable techniques, such as via application of an inverse perspective transform on the live video data. Processor 110 may obtain instructions from collision notification module 124 to determine a following distance and issue an alert if an estimated distance to the vehicle is less than a threshold recommended following distance (RFD). When a plurality of vehicles are determined to be present in the live video data, such as a first vehicle directly in front (in the same lane as the vehicle within which the navigation device 102 is located) and a second vehicle in an adjacent lane, processor 110 may identify a single vehicle of interest and determine a following distance to that vehicle. For instance, processor 110 may obtain instructions from collision notification module 124 to determine a recommended following distance (RFD) to the first vehicle directly in front while continuing to monitor the estimated distance to the second vehicle present in an adjacent lane.

Embodiments include processor 110 causing an alert to be sounded (e.g., a buzzer, beeper, etc., integrated as part of navigation device 102) and/or causing a warning to be displayed on display 112, etc., when the calculated estimated distance is less than a threshold RFD.

In various embodiments, the RFD may be calculated using the speed of the vehicle in which navigation device 102 is installed. The calculation of speed may be determined by leveraging the geographic location data generated via location determining component 114, advantageously allowing navigation device 102 to determine a RFD from changes in geographic location data without the need to communicate with onboard vehicle systems.

Using the vehicle speed, processor 110 may calculate the RFD based upon any suitable number and/or type of calculations, such as the “two-second rule,” for example, which is calculated based upon the estimated distance traversed by the vehicle over two seconds at the current speed. In various embodiments, processor 110 may use the same calculation for RFD regardless of the time of day, increase the threshold RFD for lighting considerations during the nighttime, increase the threshold RFD calculation as the speed of the vehicle increases (e.g., using a two-second rule below 45 mph but a three-second rule in excess of 45 mph), etc.

Additional location-based data may be used by processor 110 to calculate the RFD. For example, navigation device 102 may retrieve data from external computing devices 150 and/or 160 related to weather conditions. The RFD calculation may be increased in the event of weather conditions that may impact visibility or vehicle traction, such as rain, snow, sleet, ice, etc. In another example, navigation device 102 may retrieve data from external computing devices 150 and/or 160 related to traffic conditions. The RFD calculation may be impacted due to traffic flow and/or average traffic speeds due to congestion.

FIGS. 2A-2C are schematic illustration examples of user interface screens 200 used to implement a navigation device as a driving recorder, according to an embodiment. In an embodiment, user interface screens 200 are examples of what may be shown on display 112 of navigation device 102, as shown and previously discussed with respect to FIG. 1. In this embodiment and additional ones disclosed herein, user interaction with various portions of screens are discussed in terms of the portions being “selected” by a user. These selections may be performed via any suitable gesture, such as a user tapping his or her finger (or stylus) to that portion of the screen, for example.

As shown in FIG. 2A, user interface screen 200 includes portions 202, 204, 206, 208, 210, 212, 214, and 216. As further discussed below, each respective portion of user interface screen 200 may include a suitable indicia, label, text, graphic, icon, etc., to facilitate user interaction with navigation device 102 and/or to provide feedback from navigation device 102 to a user.

In an embodiment, portion 202 of user interface screen 200 provides information regarding an indication of the vehicle within road lanes and may be used in conjunction with the road lane departure notification system, the details of which are further discussed with reference to FIGS. 4A-4D. The graphic in front of the vehicle also indicates that the collision notification system is enabled, the details of which are further discussed with reference to FIGS. 7A-7C.

In an embodiment, portion 204 of user interface screen 200 provides a graphic that, when selected by a user, saves live video data to another portion of the navigation device 102. For example, the screen shown in FIG. 2A may correspond to a previously discussed embodiment whereby the navigation device continuously records live video data into a rolling buffer. Continuing this example, embodiments include a user selecting portion 204, resulting in the contents of the rolling buffer being transferred to memory 118. In embodiments, a graphic (e.g., a check mark) may be presented over or shading applied to portion 204 to indicate that the live video data has been saved to memory 118.

In an embodiment, portion 206 of user interface screen 200 provides a graphic that, when selected by a user, toggles the recording mode. As shown in FIG. 2A, the recording mode is set to on, which may correspond to a default setting, one that is displayed upon the navigation device 102 detecting a suitable recording trigger, etc. In some embodiments, a user may select portion 206 to manually start, pause, and stop recording, as shown by the changes to portion 206 in FIGS. 2A-2B. In embodiments, a user selection of portion 206 may cause user interface screen 200 to present the live video data to enable a user to view the video that is being recorded. As shown in FIG. 2C, user interface screen 200 may present an “X” over portion 206 if live video data may not be obtained at the moment. For instance, memory 118 may be full or, for embodiments in which memory 118 is removable (e.g., SD card), removed from navigation device 102.

In an embodiment, portion 206 of user interface screen 200 may also function to display the current recording state as feedback regardless of whether the recording is controlled manually or automatically. For example, screen 200 of FIG. 2A may be displayed upon a user starting to drive, while of user interface screen 200 of FIG. 2B may be displayed once a storage trigger (e.g., an accident) has been detected after the recording has started, indicating that the recording has been momentarily paused so as not to lose the captured live video data within the contents of the buffer. A user may then select portion 204, as shown in FIG. 2B, to save the live video data. Of course, as previously discussed, the captured live video data may be stored automatically upon detection of the storage trigger and not require user intervention.

To provide another example, user interface screen 200, as shown in FIG. 2C, may be displayed to indicate that recording is not possible at the moment, which may be a result of a user removing memory card 118 or a result of a full memory card 118.

In an embodiment, portions 208 and 210 of user interface screen 200 facilitate user interactions with the navigation device. For example, a user may select portion 208 to open a menu to adjust settings, options, etc. A user may select portion 210 to exit the current navigation screen 200 and perform other functions provided by the navigation device, such as viewing recorded video, returning to a home screen, entering a new address or waypoint, etc.

In an embodiment, portions 212, 214, and 216 of user interface screen 200 provide navigational information to a user. For example, portion 212 may display an approximate distance to and direction of the next turn on way to the user's selected destination, while portion 214 may display the name of the street or exit (e.g., text on exit sign) that should be used to reach the selected destination. Furthermore, portion 216 may include an actively updating navigational map indicating the position of the vehicle along a designated navigation route, the vehicle's position along the route, etc.

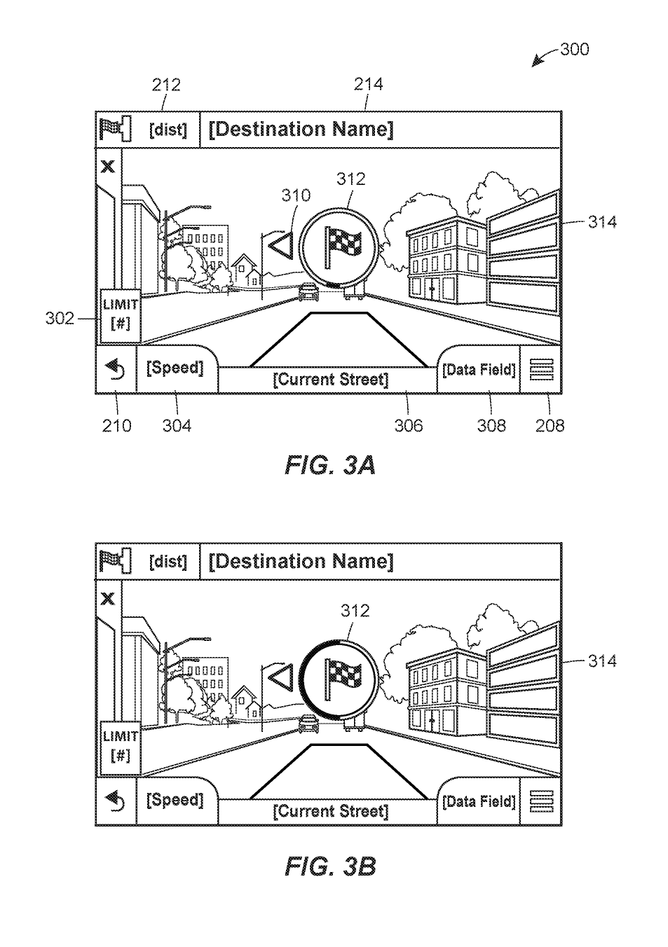

FIGS. 3A-3B are schematic illustration examples of user interface screens 300 used in conjunction with a navigation system, according to an embodiment. In these embodiments, user interface screens 300 include live video 314 of the road and/or other objects in front of the vehicle captured by camera 116 of the environment in front of the vehicle in which navigation device 102 is mounted. In an embodiment, user interface screens 300 are examples of what may be displayed on display 112 of navigation device 102, as shown and previously discussed with respect to FIG. 1.

In an embodiment, user interface screens 300 represent a different view from user interface screens 200, as shown in FIGS. 2A-2C. For example, as shown in FIG. 3A, user interface screen 300 also includes portions 208, 210, 212, and 214, as previously discussed with respect to FIGS. 2A-2C. User interface screen may alternatively or additionally include portions 302, 304, 306, and 308.

Portion 302 may indicate a speed limit for the current road on which the vehicle is traveling, the current road being displayed in portion 306. The speed limit may be part of the cartographic data that is stored in memory 118. The current calculated speed of the vehicle may also be displayed in portion 304, and any other suitable data field may be displayed in portion 308 (e.g., compass direction, a time of day, an estimated arrival time, etc.).

However, instead of displaying an actively updating navigational map in portion 216, as previously discussed with reference to FIG. 2A-2C, portion 216, as shown in FIG. 3A, indicates a view of the real time video captured by camera 116 and additional icons 310 and 312. Icon 310 includes a direction of the street on which the destination may be found, while icon 312 indicates a scaled indicator of the approximate distance remaining to the destination.

As the vehicle approaches the destination, embodiments include the circular indicator progressing in a clockwise fashion, as shown by the change in icon 312 between FIG. 3A and FIG. 3B. In various embodiments, portion 216 may transition from the actively updating navigational map shown in FIGS. 2A-2C to the real time video shown in FIGS. 3A-3B when the vehicle is within a threshold distance of the destination (e.g., less than 500 feet, less than a quarter mile, etc.). Upon transitioning, the live video may be displayed superimposed with icons 310 and 312. Additionally or alternatively, markers or other guidance tools may be overlaid on the live video data in portion 216, as shown in FIGS. 3A and 3B, to mark the destination. In this way, a user may quickly ascertain a remaining distance to a destination by looking at the live video data shown in portion 216, which incorporates a more familiar view ordinarily seen from a driver's perspective while approaching the destination.

FIGS. 4A-4D are schematic illustration examples of user interface screens 400 used to implement a navigation device in conjunction with a lane departure notification system, according to an embodiment. In an embodiment, user interface screens 400 are an example of information that may be shown on display 112 of navigation device 102, as shown and previously discussed with respect to FIG. 1.

In an embodiment, user interface screens 400 represent a different view from user interface screens 200, as shown in FIGS. 2A-2C. For example, as shown in FIG. 4A, user interface screen 400 also includes portions 202, 204, 206, 208, 210, and 216, as previously discussed with respect to FIGS. 2A-2C. User interface screens 400 may alternatively or additionally include other portions, such as portion 402, as shown in FIG. 4D and further discussed below.

In an embodiment, user interface screens 400, as shown in each of FIGS. 4A-4D, include the same actively updating navigational map in each respective portion 216 and the same driving recorder status in each respective portion 206, but the lane departure notification displayed in portion 202 is varied among each of FIG. 4A-4D. The graphic in front of the vehicle within portion 202 likewise indicates that the collision notification system is enabled in each of FIGS. 4A-4D, the details of which are further discussed with reference to FIGS. 7A-7C.

As shown in FIG. 4A, portion 202 includes a right lane line marker 402 to the right of the vehicle icon, but no line to the left of the vehicle icon. In an embodiment, portion 202, as shown in FIG. 4A, corresponds to a situation in which navigation device 102 has detected and is tracking a road lane line on the right side of the vehicle, but has not detected and is not tracking a road lane line to the left of the vehicle. This situation could represent the absence of a road lane line on the left side of the vehicle, a period of time in which the vehicle turned onto the road before navigation device 102 has been able to identify the left road lane line, a brief non-continuous segment of the left road lane line, etc.

In accordance with the information shown in portion 202, as shown in FIG. 4A, embodiments include navigation device 102 tracking the right road lane line such that, when the vehicle crosses over this lane line, the alarm will be issued. Departure of the vehicle to the left side may not result in the issuance of an alert because, as shown in FIG. 4A, the left road lane line is not being tracked.

As previously discussed, the cartographic data stored in navigation device 102 may be leveraged by processor 110 to determine whether to issue an alert when the vehicle crosses a road lane line. As shown in FIG. 4B, the navigation device 102 is tracking both the left and the right road lane lines, but will only issue an alert for the departure of the vehicle over the right road lane line, which is indicated by the muted left lane line marker 404 to the left of the vehicle icon as shown in portion 202.

In the scenario illustrated by FIG. 4B, navigation device 102 may determine, for example, that the lane line to the right of the vehicle is a solid lane line, thereby unconditionally issuing an alert when the vehicle crosses this lane line regardless of the type of road. Further continuing this example, navigation device 102 may determine that the road lane line to the left of the vehicle is a dashed road lane line and, from the cartographic data stored in memory of navigation device 102, that the vehicle crossing the left road lane line would not cause the vehicle to cross into oncoming traffic. Therefore, as indicated by indicated by the right lane line marker 402 and muted left lane line marker 404, as shown in portion 202 of FIG. 4B, navigation device 102 may issue an alert when the vehicle crosses the right road lane line, but suppress the alert when the vehicle crosses the left road lane line.

In the scenario illustrated by FIG. 4C, the navigation device 102 is tracking both the left and the right road lane lines and will issue an alert for the departure of the vehicle over either one of these lanes, which is indicated by the right lane line marker 402 and the left lane line marker 404 in portion 202 of FIG. 4C, which may have the same color, shading, etc.

In the scenario illustrated by FIG. 4C, navigation device 102 may determine, for example, that the lane line to the right of the vehicle is a solid lane line, thereby unconditionally issuing an alert when this lane is crossed regardless of the type of road. Further continuing this example, navigation device 102 may determine that the road lane line to the left of the vehicle is a dashed road lane line and, from the cartographic data stored in memory of navigation device 102, that crossing the left road lane line would cause the vehicle to cross into oncoming traffic. Therefore, as indicated by indicated by the right lane line marker 402 and left lane line marker 404, as shown in portion 202 of FIG. 4C, navigation device 102 may issue an alert when the vehicle crosses either the right road lane line or the left road lane line.

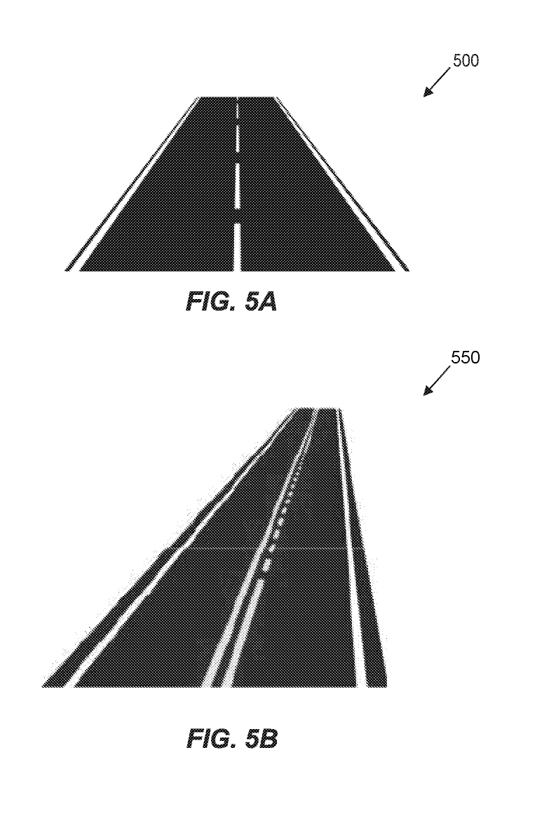

The difference between the scenarios in FIGS. 4B and 4C may be further illustrated with reference to FIGS. 5A-5B. FIG. 5A illustrates an example of a one-way street, while FIG. 5B illustrates a two-lane undivided highway. In either case, navigation device 102 may issue an alert when the vehicle crosses the right road lane line, as this line is solid in both cases.

However, if navigation device 102 determines, from the cartographic data, that the vehicle is traveling on the one-way street of FIG. 5A, then navigation device 102 may suppress the issuance of an alarm when the vehicle moves across the left dashed road lane line, as indicated by the muted left lane line marker 404 to the left of the vehicle icon as shown in portion 202 of FIG. 4B.

Furthermore, if navigation device 102 determines, from the cartographic data, that the vehicle is traveling on the undivided highway of FIG. 5B where the center right lane becomes broken—indicating a passing lane, then navigation device 102 may cause an alert to be issued when the vehicle departs either the right road lane line or the left road lane line, as indicated by the left lane line marker 404 in portion 202 of FIG. 4C.

In the scenario illustrated by FIG. 4D, the navigation device is tracking both the left and the right road lane lines and has issued an alert for the vehicle crossing the left road lane line. Again, the alert may be issued via any suitable combination of warnings displayed on screen 400 (e.g., portion 406) and/or audible warnings. Embodiments include the left lane line marker 404, as shown in FIG. 4D, changing color, shading, line weight, etc., from the left lane line marker 404, as shown in FIG. 4C, to indicate that the left road lane line has been crossed by the vehicle.

The indicators shown in portion 202 of FIGS. 4A-4D may be represented by any suitable type of indicator to convey the information represented by the road lane lines to the left and right of the vehicle icon, such as different line weights, color schemes, the use of broken lines, color muting, fading, etc. For example, a road lane line that will result in the issuance of an alert when crossed may be displayed in a different color than a road lane line that will not. To provide another example, a road lane line that will result in the issuance of an alert when crossed may be displayed in one color while a road lane line that will not may be grayed out or faded. To provide yet another example, a road lane line color may change when crossed and when an alert has been issued (e.g., from green to yellow or red).

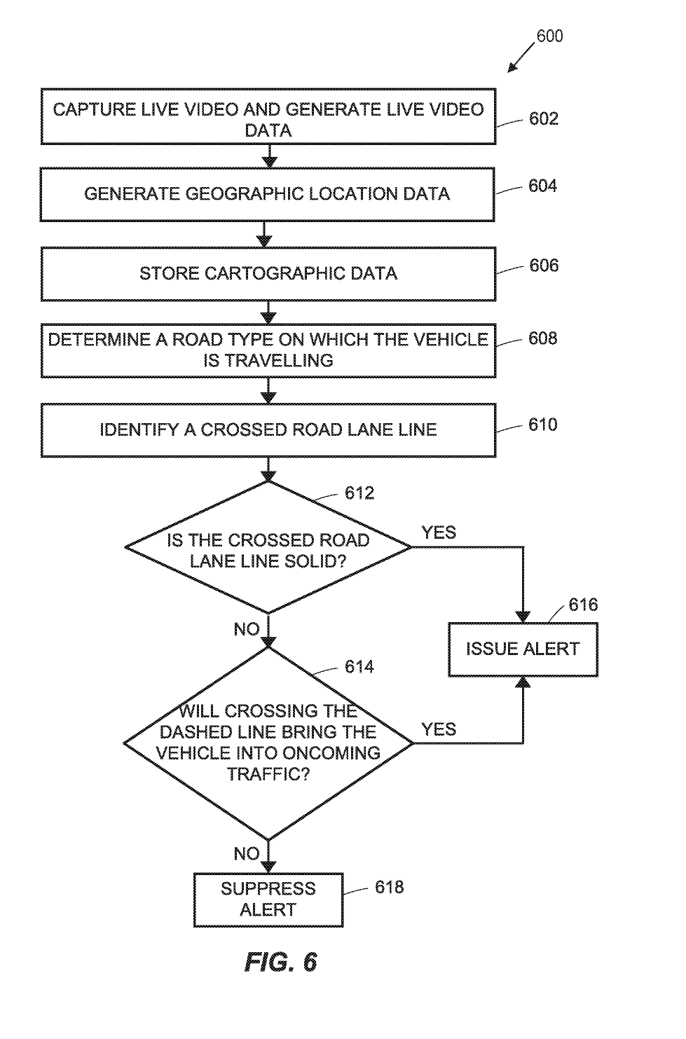

FIG. 6 illustrates a method flow 600, according to an embodiment. In an embodiment, one or more regions of method 600 (or the entire method 600) may be implemented by any suitable device. For example, one or more regions of method 600 may be performed by navigation device 102, as shown in FIG. 1.

In an embodiment, method 600 may be performed by any suitable combination of one or more processors, applications, algorithms, and/or routines, such as processor 110 executing instructions stored in lane departure notification module 122, for example, as shown in FIG. 1. Further in accordance with such an embodiment, method 600 may be performed by one or more processors working in conjunction with one or more components within a navigation device, such as one or more processors 110 working in conjunction with one or more of communication unit 104, user interface 106, sensor array 108, display 112, location determining component 114, camera 116, memory 118, etc.

Method 600 may start when one or more processors capture live video and generate live video data (block 602). In an embodiment, the live video data may include, for example, dash cam video such as a view of a road in front of the vehicle in which navigation device 102 is mounted (block 602). The live video data may include, for example, road lane line markers on the road (block 602).

Method 600 may include one or more processors 110 generating geographic location data indicative of a geographic location of the navigation device (block 604). This may include, for example, location determining component 114 and/or processor 110 receiving and processing one or more GNSS signals to generate the geographic location data (block 604).

Method 600 may include one or more processors 110 storing cartographic data (block 606). The cartographic data may include, for example, information regarding road types, speed limits, road architecture, lane layouts, etc. (block 606). The cartographic data may be preinstalled or otherwise downloaded to memory 118 (block 606).

Method 600 may include one or more processors 110 determining a road type on which the vehicle is traveling (block 608). This determination may be made, for example, by processor 110 referencing the cartographic data stored by one or more processors 110 (block 606) to the geographic location data generated one or more processors 110 (block 604) to identify the type of road on which the vehicle is traveling as a one-way street, a divided highway, an undivided highway, etc. (block 608).

Method 600 may include one or more processors 110 identifying when a road lane line has been crossed by the vehicle (block 610). This determination may be made, for example, by processor 110 analyzing movements of the road lane lines within the live video data, as previously discussed with reference to FIG. 1 (block 610).

Method 600 may include one or more processors 110 determining whether a crossed road lane line is a solid line (block 612). This may include, for example, one or more processors 110 comparing pixel dimensions among lines identified via a suitable edge detection process, as previously discussed with reference to FIG. 1, to differentiate between solid and dashed road lane lines (block 612).

If the crossed road lane line is solid, method 600 may include one or more processors 110 causing an alert to be issued (block 616). In an embodiment, the one or more processors 110 may cause the alert to be issued each time a solid road lane line is crossed regardless of the road type (block 616). Again, the issued alert may be any suitable combination of visual and/or audible warnings (block 616).

If the crossed road lane line is not a solid line, then method 600 may include one or more processors 110 determining whether crossing the dashed road lane line will cause the vehicle to move into oncoming traffic (block 614). This may be determined by comparing the road type determined by one or more processors 110 for the road on which the vehicle is traveling (block 608) to the lane position of the vehicle within the road (block 614). If so, method 600 may include one or more processors 110 causing an alert to be issued (block 616). If not, method 600 may include one or more processors 110 suppressing the alert (block 618).

FIGS. 7A-7C are schematic illustration examples of user interface screens 700 used to implement a navigation device in conjunction with a collision notification system, according to an embodiment. In an embodiment, user interface screens 700 are an example of information that may be shown on display 112 of navigation device 102, as shown and previously discussed with respect to FIG. 1.

In an embodiment, user interface screens 700 represent a different view of both user interface screens 200, as shown in FIGS. 2A-2C, and user interface screens 400, as shown in FIGS. 4A-4C. For example, as shown in FIG. 7A, user interface screen 700 also includes portions 202, 204, 206, 208, 210, 212, and 214, as previously discussed with respect to FIGS. 2A-2C. User interface screens 700 may alternatively or additionally include other portions, such as portion 704, as shown in FIG. 7C and further discussed below.

User interface screens 700, in each of FIGS. 7A-7C, show the same actively updating navigational map in each respective portion 216, the same driving recorder status in each respective portion 206, and the same lane departure notification indicia in portion 202, but the collision notification system graphics in portion 202 is varied among each of FIGS. 7A-7C. More specifically, icon 702 in front of the vehicle within portion 202 varies between each of FIG. 7A-7C.

As shown in FIG. 7A, portion 202 of user interface screen 700 includes a vehicle icon but does not include icon 702. In an embodiment, portion 202, as shown in FIG. 7A, corresponds to a situation in which the collision notification system is not enabled and/or is not currently active. This situation could occur, for example, if a user has manually disabled the collision notification system via one or more selected options. In some embodiments, the activation of the collision notification system may be automatically enabled once the vehicle speed exceeds a threshold value (e.g., 5 mph, 10 mph, etc.). In accordance with such embodiments, icon 702 may be absent until the threshold speed has been attained, in which case the collision notification system may be activated and icon 702 may be present in portion 202, as shown FIG. 7B.

In the scenario illustrated by FIG. 7B, portion 202 of user interface screen 700 indicates that the collision notification system has been enabled. In accordance with an embodiment, upon activation of the collision notification system, processor 110 may begin classifying live video data but continue to display the actively updating navigational map in portion 216. In other words, embodiments include processor 110 classifying live video data as part of a background process while the user is still able to utilize the navigation functions provided by the navigation device 102.

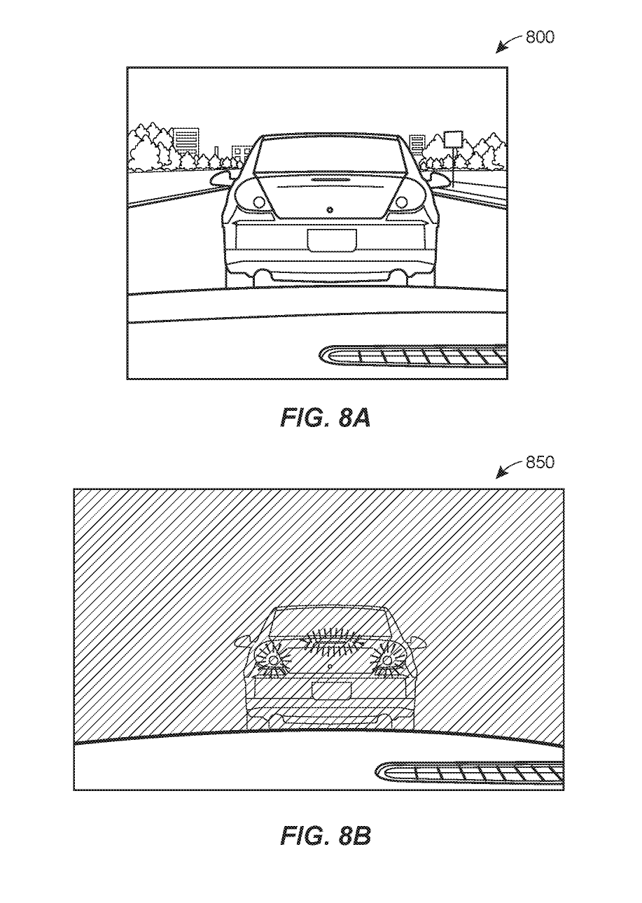

An example of live video data that may be captured while the collision notification system is enabled is shown in FIG. 8A-8B, each indicating a sample frame of live video data captured during the daytime (800) and nighttime (850). A comparison between the live video data frames 800 and 850 demonstrate the stark differences between rear vehicle features for live video data captured during the daytime versus the nighttime. Because the classification process attempts to identify these features and thus identify the vehicle within the live video feed, the use of daytime and nighttime training data models may advantageously allow for the classification system to adapt to these changes.

Again, when the collision notification system is active, as indicated by the graphic shown in portion 202 of FIG. 7B, embodiments include processor 110 classifying live video captured during the daytime (e.g., live video data frame 800) using a classification process that compares features of the daytime live video feed to daytime training data models. Furthermore, when the collision notification system is active, embodiments include processor 110 classifying live video captured during the nighttime (e.g., live video data frame 850) using a classification process that compares features of the nighttime live video feed to nighttime training data models.

Again, when a vehicle in the captured live video data is identified, embodiments include processor 110 calculating an estimated distance between the navigation device 102 (and the vehicle within which the navigation device 102 is located) and the identified vehicle using any suitable techniques, as previously discussed with reference to FIG. 1. In an embodiment, this calculation may also be performed while screen 700 is displayed, as shown in FIG. 7B, allowing a user to continue to utilize navigational functions provided by navigation device 102.

In the scenario illustrated by FIG. 7C, portion 202 indicates that the collision notification system has detected that the calculated estimated distance between navigation device 102 (and the vehicle within which the navigation device 102 is located) and the vehicle identified in the live video data is less than a threshold RFD, causing processor 110 to issue an alert. Again, the alert may be issued via any suitable combination of warnings displayed on screen 700 (e.g., portion 704) and/or audible warnings. Embodiments include navigation device 102 issuing the alert while still providing navigation functions.

Embodiments include icon 702, as shown in portion 202 of FIG. 7B, changing color, shading, line weight, etc., to illustrate that an alert has been detected, as shown in FIG. 7C. The change between these states may be shown using any suitable type of indicators, such as changes in color, muting, fading, etc. For example, icon 702, as shown in FIG. 7B, may be one color to indicate that the collision notification system is active (e.g., green) but change to another color when the alert is issued (e.g., red), as shown in FIG. 7C.

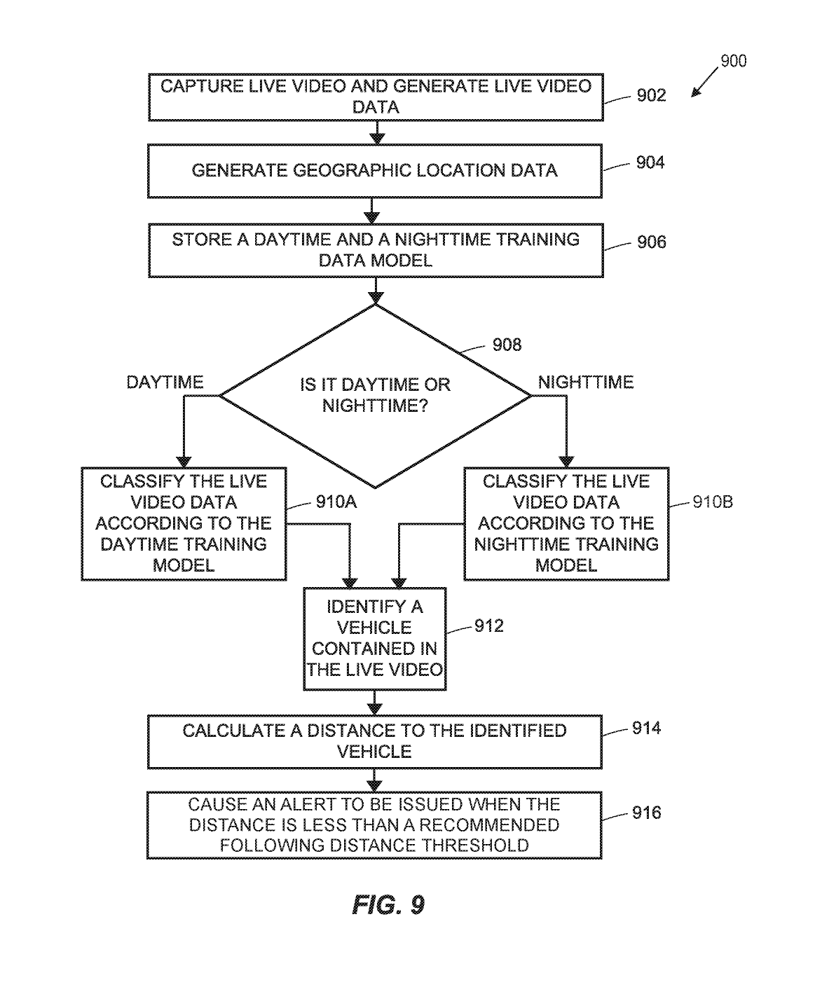

FIG. 9 illustrates a method flow 900, according to an embodiment. In an embodiment, one or more regions of method 900 (or the entire method 900) may be implemented by any suitable device. For example, one or more regions of method 900 may be performed by navigation device 102, as shown in FIG. 1.

In an embodiment, method 900 may be performed by any suitable combination of one or more processors, applications, algorithms, and/or routines, such as processor 110 executing instructions stored in collision notification module 124, for example, as shown in FIG. 1. Further in accordance with such an embodiment, method 900 may be performed by one or more processors working in conjunction with one or more other components within a navigation device, such as processor 110 working in conjunction with one or more of communication unit 104, user interface 106, sensor array 108, display 112, location determining component 114, camera 116, memory 118, etc.

Method 900 may start when one or more processors 110 capture live video and generate live video data (block 902). In an embodiment, the live video data may include, for example, dash cam video such as a view of a road in front of the vehicle in which navigation device 102 is mounted (block 902).

Method 900 may include one or more processors 110 generating geographic location data indicative of a geographic location of the navigation device 102 (block 904). This may include, for example, location determining component 114 and/or processor 110 receiving and processing one or more GNSS signals to generate the geographic location data (block 904).

Method 900 may include one or more processors 110 storing a daytime and a nighttime training data model (block 906). The daytime training data model may include, for example, training data including a first range of video data metrics that identify a portion of a vehicle contained within the live video data during the daytime (block 906). The nighttime training data model may include, for example, training data including another range of video data metrics that identify a portion of a vehicle contained within the live video data during the nighttime (block 906).

Method 900 may include one or more processors 110 determining whether it is daytime or nighttime based upon the geographic location data and a time of day (block 908). Again, the daytime/nighttime determination may be performed using any suitable techniques, such as the referencing the geographic location data (block 904) to data stored in memory 118 to determine sunrise/sunset times and comparing the time of day to the sunrise/sunset times (block 908).

If the one or more processors 110 determine that is it daytime (block 908), then method 900 may include the one or more processors 110 classifying the live video data according to the daytime training model (block 910A) that is stored in memory (block 906). But if the one or more processors 110 determine that is it nighttime (block 908), then method 900 may include the one or more processors 110 classifying the live video data according to the nighttime training model (block 910B) that is stored in memory (block 906). Again, this classification may be performed utilizing any suitable number and/or types of classifier algorithms (blocks 910A and 910B).

Method 900 may include one or more processors 110 identifying the vehicle contained within the live video (block 912) using the applied classification algorithm (block 910A or 910B). For example, when installed within a vehicle, method 900 may include one or more processors 110 identifying a vehicle in front of the vehicle in which the navigation device 102 is installed (block 912).

Method 900 may include one or more processors 110 calculating an estimated distance from the navigational device 102 to the identified vehicle (block 912) using the portion of the vehicle contained within the live video data (block 914). This may include, for example, one or more processors 110 performing an inverse perspective transform on the live video data to determine this estimated distance (block 914).

Method 900 may include one or more processors 110 causing an alert to be issued based upon the estimated distance (block 916). This alert may be, for example, a visual and/or audible alert generated by the navigation device 102 (block 916). The alert may be issued, for example, when the calculated estimated distance between the navigation device 102 (and the vehicle within which the navigation device 102 is located) and the vehicle (block 914) is less than a RFD threshold (block 916).

In configurations, the navigation device 102 may allow a user to store images of specific locations captured by the camera 116. These images may be stored in any suitable portion of memory 118, along with location information, a name or other identifier such as an icon, or any other pertinent data. Images may be captured in frequently visited locations, such as a parking spot or garage space. This process may be initiated by the user via the user interface 106 or suggested by the navigation device 102 upon repeated visits to a particular location. For example, a user may wish to capture an image while parked in his or her usual parking space in his or her home garage while in the ideal parking position. This image, a reference image, may be tagged with location data and configured with a name or other identification.

Upon capture, the reference image may be analyzed to detect features that may be used later for comparison. For example, doors or other fixtures may be detected that are unlikely to change position. Cleanup or masking may be done to the reference image to remove interference (e.g., hood reflection). There may be one or more reference images for a particular location. If multiple reference images exist, the user may select a master image to be used by default for comparison or the navigation device 102 may select a master image to be used by default. Additionally or alternatively, the navigation device 102 may be configured to select a master (or best) image based on quality, number of detected features, the viewing angle, lighting conditions, time of day (e.g., daytime or nighttime), or any other appropriate data points.

Upon return to this known location, the reference image may be compared to the live video feed or image captures from the camera 116 to assist the user with parking in the location. Features may be detected in the frames of the live video feed or periodic images captured by the camera 116 for comparison to the reference image. If cleanup or masking was done to the reference image, the same cleanup or masking may be done to the live video feed or captured images to avoid false positives. Homographic comparison may be done between the reference image and the frames of the live video feed or periodic images captured by the camera 116 to determine the vehicle's position relative to the ideal parking position as captured in the reference image. Guidance may be given in any appropriate manner, such as a textual prompt, an audio prompt (e.g., a beep or spoken guidance), or a visual prompt (e.g., icons that converge as the driver gets closer to the correct position).

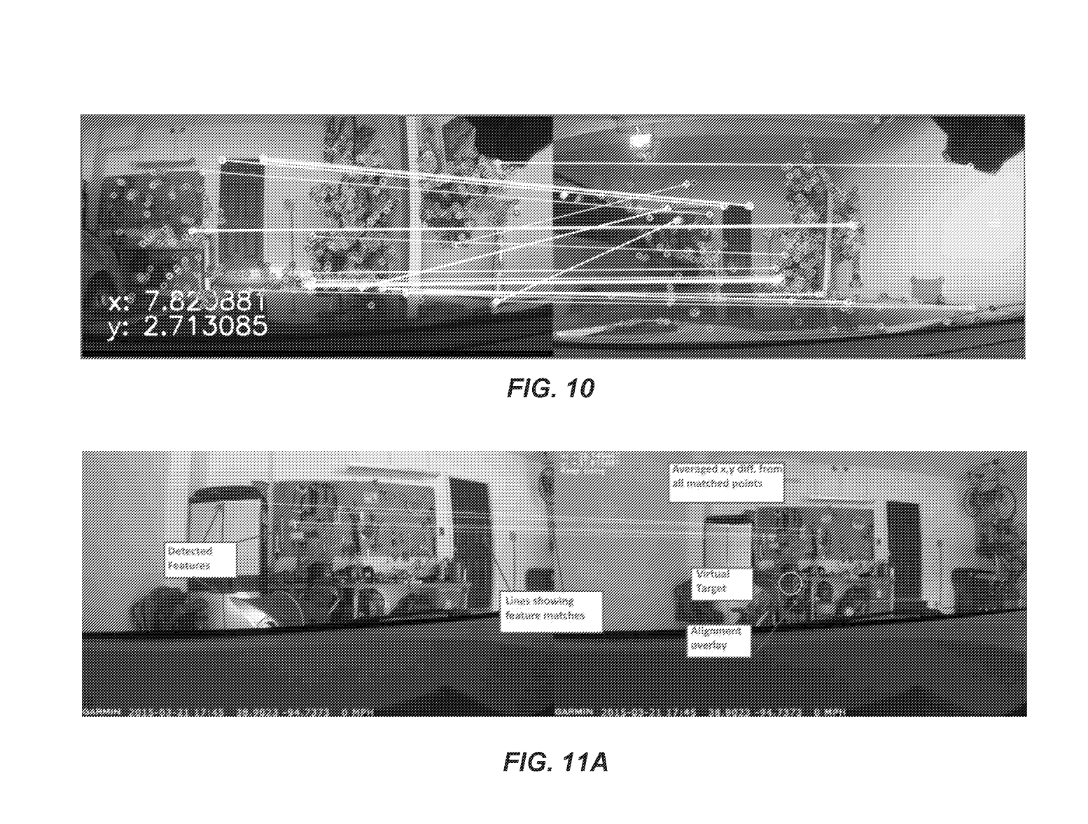

FIG. 10 shows an exemplary feature detection and homographic comparison between a reference frame on the left and the current camera view on the right. Detected features are marked with circles, and white lines join matched features between the reference frame and the current comparison image. The x,y values are the differences between the matched points. As those values near 0,0, the driver nears his or her target. Broadly, features are points that will remain constant in the desired parking area between the time the reference frame is captured and the time when the user is parking. For example, corners with sharp contrast may be particularly suited for use in reference images. As shown in FIG. 10, the corners of the doorframe are identified as features that can be matched between the reference image and a subsequent comparison image.

Additionally, incorrect feature matches occurring with similar objects or moving objects (e.g., people, pets, an opening door, etc.) could be detected. For instance, in FIG. 10, there are three feature match lines that are diagonal in nature instead of substantially horizontal as most of the feature match lines. These are mismatches, and they may be detected by the angle of the lines and not considered when generating the x,y values to be used in guiding the driver. Thus, only the strongest matches (i.e., those with the highest match confidence) may be used for convergence detection. For example, only the 20 best lines might be used. Alternatively, only those matches with confidence above a predetermined threshold (e.g., 90%) might be used. Furthermore, the x,y offsets for matched features can be averaged such that good convergence can be determined even in the presence of incorrectly matched points. Any remaining mismatches or moving objects may be filtered out using algorithms, thresholds, or other quality detection methods.

In some embodiments, when a reference image is captured, the features identified may be displayed to the user so that transient features can be deselected. For example, if an empty cardboard box is being stored in the users garage waiting for garbage pickup when a reference frame is captured, the corners of the box may be identified as features. However, when the user subsequently parks, the box may no longer be present. As such, the user may indicate that those features corresponding to the box should be deselected.

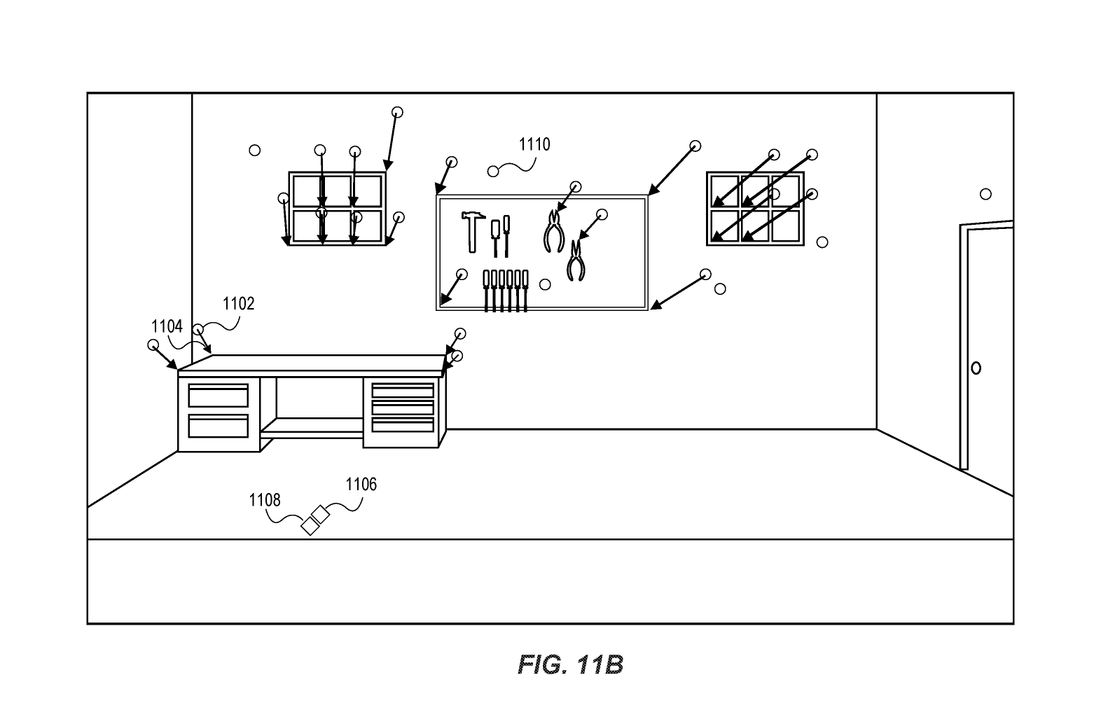

FIG. 11A shows an exemplary homographic comparison between a reference frame on the left and the current camera view on the right and how it may be used to guide the driver into the ideal parking spot. In this example, features have been detected in each image. For ease of reference, lines are drawn to show the relative positions of detected features in each image. As can be seen, only a subset of the matched features have been used to determine convergence. As an exemplary visual indicator, a virtual target has been displayed as a first circle in the right image as a guide for the driver. A second circle is displayed to indicate to the driver his or her relative distance to the target and/or his or her current trajectory. As described below, other visual indicators are also contemplated. FIG. 11A further depicts one technique for determining convergence: as with FIG. 10, the x,y values are the differences between matched points. As those values decrease the driver nears his or her desired parking location. In some embodiments, the target circle may shrink, grow, change color or otherwise change appearance as the vehicle approaches the target. All boxes, lines, and other markers are provided for reference only in this example and may or may not be included in the visual representation displayed to the driver.

Differing lighting conditions or angles of the navigation device 102 or its camera 116 may impact homographic comparison. In appropriate situations, using an alternative image captured in different conditions or at different angles, may yield better results. As described in additional detail below, the navigation device 102 may be configured to make this determination automatically or it may be prompted by user input or interaction.

Turning now to FIG. 11B, an alternate view of the determination of the convergence point for the features of the reference image and a comparison image is depicted. In particular, locations for a plurality of features 1102 identified in the reference image are overlain on the current comparison image. Features matched to the current comparison image with high confidence (as discussed above) are identified with corresponding features 1104 in the comparison image. The lines between matched features will converge at a convergence point 1106 (or within a relatively small radius around convergence point 1106). If matched features such as feature 1110 do not converge to the region around convergence point 1106, they can be discarded as false matches as described above with respect to FIG. 10.

Convergence point 1106 can be tracked between subsequent comparison images using a moving average, weighted moving average, or other aggregation technique to obtain average convergence point 1108. Convergence points 1106 and 1108 can be located anywhere within the reference image. In some configurations, points 1106 and 1108 may be located within the reference image along the direction of movement of device 102 including, for example, near the center of the reference image. Because vehicles typically move slowly when parking, average convergence point should also move slowly. Thus, for example, if an unusually large number of feature mismatches (such as feature 1110) cause convergence point 1106 to be incorrectly determined, it will be far from average convergence point 11088 and can be discarded. The proximity to the desired parking location can then be determined based on the convergence point or on the average distance between matched features 1102 and their corresponding features 1104. Additionally or alternatively, the proximity to the desired parking location can be determined other than through distance and/or average distance calculations between matched features 1102 and their corresponding features 1104. For example, rotational matching, the use of parallel lines, offset determinations, and other matching functions may be utilized to determine proximity to the desired parking location.

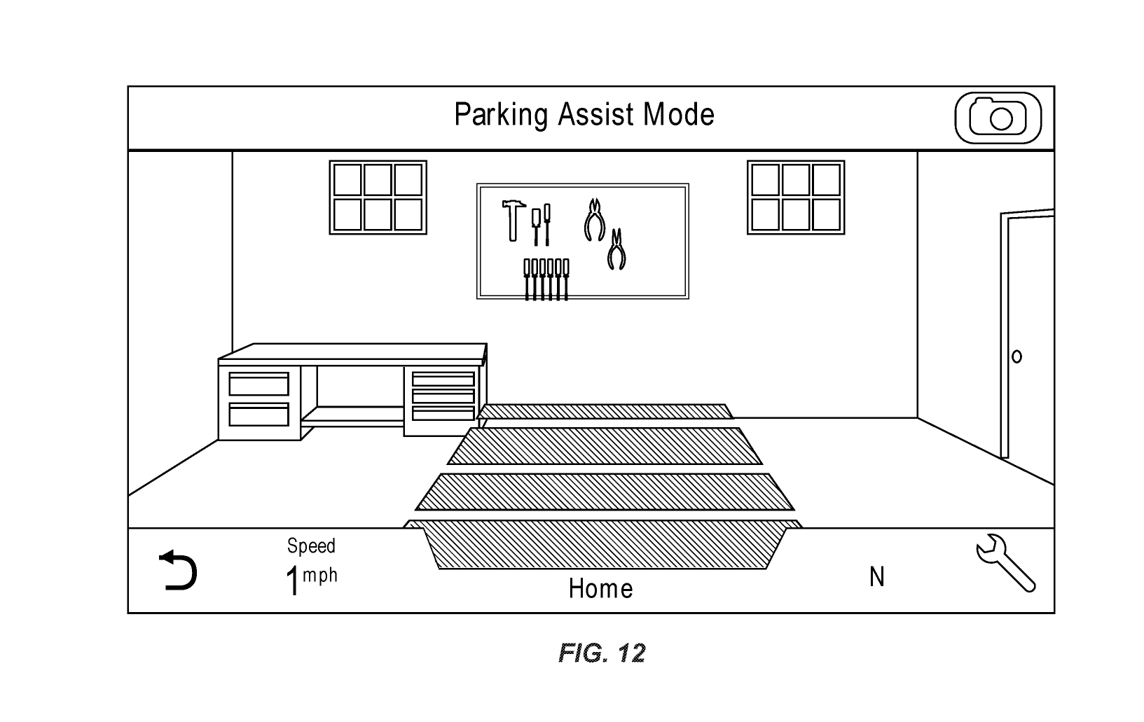

Turning now to FIG. 12, another view of the comparison image overlain with an alternative visual proximity indicator is depicted. In the depicted embodiment, the visual proximity indicator indicates to the user the range to the desired parking location rather than the direction. For example, the depicted crosswalk path for the vehicle may be animated such that it moves faster when the vehicle is further away from the desired parking location, and slows down as the user approaches the desired parking location, and stops when the user has reached the desired parking location. In other embodiments, the color of the crosswalk overlay may change as the user approaches the desired parking location. For example, the crosswalk may be gray before the system has identified enough features to determine convergence, green if the system has determined convergence and the vehicle is far away from the desired parking location, yellow if the vehicle is near the desired parking location, and red once the vehicle has arrived at the desired parking location. In some embodiments, different visual representations may be combined. For example, the directional indicator of FIG. 11A may be displayed in conjunction with the range indicator of FIG. 12 to provide the user with additional parking guidance.

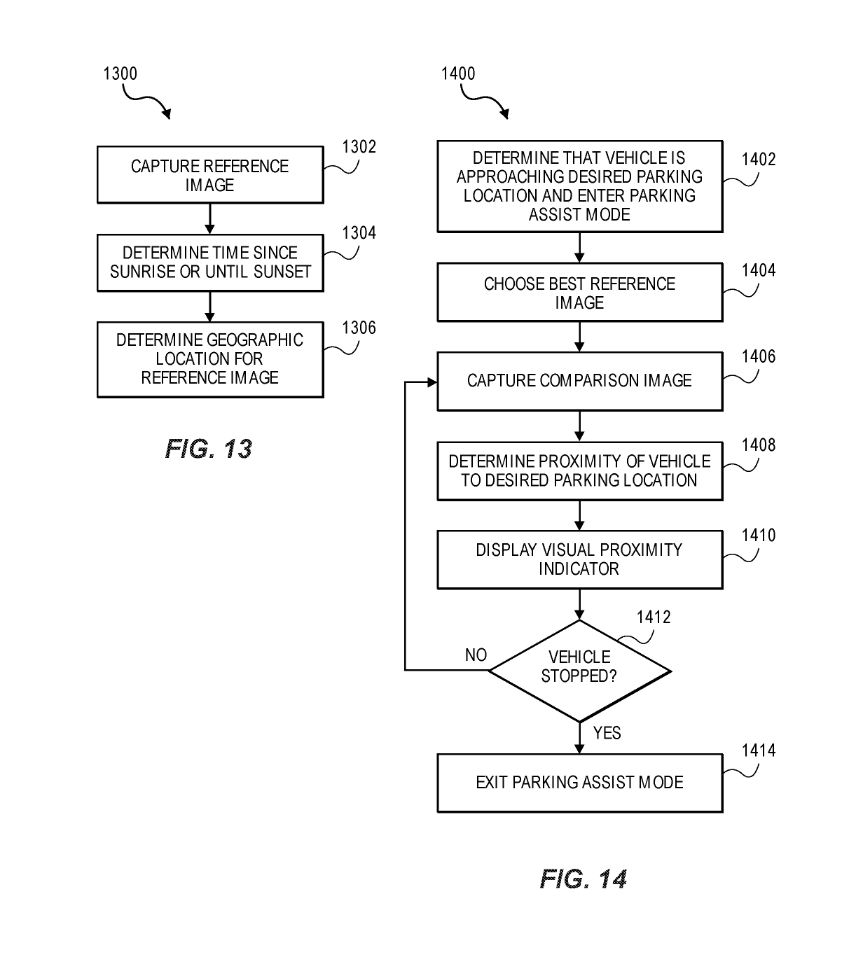

Turning now to FIG. 13, a flowchart illustrating a first method for identifying a desired parking location is depicted and referred to generally by reference numeral 1300. Although FIGS. 10, 11A, 11B, and 12 depict a the desired parking location as being in a home garage, the invention is not limited to such locations, and the methods and systems described herein are broadly applicable regardless of the parking location. As such, they are relevant whether the desired parking location is in a home garage, a public parking structure, street parking, etc. The method begins at a step 1302, when system 102 captures a reference image using camera 106. A reference image may be captured in response to a variety of triggers. For example, if memory 1118 does not have any recorded images stored and the location of the vehicle is determined to be in the desired parking location (for example, because location determining component 114 determines that the vehicle has stopped in close proximity to a location the user has stored as “Home” or to a location the map indicated as a designated parking area), the user may be prompted to set up the parking assist feature for the first time. Similarly, if a location history for the vehicle indicates that it has been repeatedly stopped in close proximity to the same location for extended periods, the user may be prompted to set up the parking assist feature. Other techniques for determining when a vehicle is at a desired parking location and parking assist should be set up are also contemplated. Alternatively, camera 116 may capture additional references images automatically or if prompted by the user. For example, if the time since sunrise or until sunrise is significantly different from existing reference images, the different lighting might warrant capturing an additional reference image to improve accuracy. Alternatively, if the user stops the vehicle before or after system 102 detects that it has reached the desired parking location, the user may be prompted to update the stored reference image (and therefore the desired parking location).

In some embodiments, the camera 116 is an integrated, front-facing camera. In other embodiments, camera 116 is another, communicatively coupled camera, such as a back-up camera or another in-vehicle or on-vehicle camera. In still other embodiment, an external camera (such as a camera mounted in a garage and connected via a Bluetooth or WiFi network such as network link 163.1 to the other components of the system) captures the image. In some embodiments, the image is captured using the ambient light. In other embodiments, supplemental light (such as a flash or external light source) is use to provide additional lighting of the scene when the image is captured.

In some embodiments, the orientation of camera 116 when the reference image is captured is recorded. For example, if the system is embodied in a smartphone containing orientation sensors such as gyroscopes, magnetometers or accelerometers, the absolute orientation of the device can be obtained from sensors array 108. Alternatively, the orientation of the camera can be obtained directly from the reference by using image processing to determine the vanishing point of the perspective in the reference image. One of skill in the art will appreciate that this is similar to the processing described above with respect to FIGS. 5A and 5B. Alternatively, a previously calculated vanishing point could be reused. In some embodiments where the orientation of camera 116 is determined, the reference image is instead preprocessed to reflect a standardized orientation prior to being stored. For example, the image may be skewed such that the optical axis of the image matches the optical axis of the vehicle, and rotated such that the top and bottom borders of the image are parallel to the ground.

Processing them proceeds to step 1304, where the system determines a relative lighting time for the reference image. The relative lighting time reflects the time after sunrise or the time until sunset, such that images captured at the same relative lighting time will be lit roughly the same by the sun, even if they are captured at different absolute times. Thus, for example, two images captured at sunrise will be lit roughly the same, even if one of them is taken at 6 am in the summer and the other is taken at 8 am in the winter. In order to determine the relative lighting time, the absolute time and the time of sunrise/sunset are determined. The former can be determined using a system clock, and the latter can be calculated using the date, the latitude, and the longitude of the desired parking location (as determined by location determining component 114). In some embodiments, the relative lighting time is instead measured by a fraction of the time from sunrise until sunset. Thus, for example, if sunrise is at 7 am and sunset is at 7 pm, a reference image captured at 10 am could be measured as 3 hours after sunrise, 9 hours before sunset, or 25% through the day. Other ways of measuring relative lighting are also contemplated as being within the scope of the invention.

Processing then proceeds to step 1306, where a geographic location for the reference image is captured. In some embodiments, this may be done using location determining component 114. In other embodiments, location determining component 114 may not be able to obtain a current location fix when the user indicates that a reference image should be captured because, for example, it relies on GPS and the vehicle is in the garage. In such cases, a last-known location for the vehicle based on the last fix from location determining component 114 can be used instead. For the purposes of this specification, the phrase “using a location determining component” applies whether the location is a current location or a last-known location for the system.

Turning now to FIG. 14, a flowchart illustrating the operation of a method for assisting the user with parking is depicted and referred to generally by reference numeral 1400. Initially, at step 1402, system 102 determines that the vehicle is approaching the desired parking location and enters parking assist mode. This can be determined, for example, by establishing a geofence (such as, for example, a circular area with radius 20 feet, 100 feet or 500 feet surrounding the desired parking location or an irregular area comprising a know approach to the desired parking location) around the geographic location for the reference image and triggering once the vehicle enters that geofenced region. In some embodiments, the user may have more than one desired parking location (for example, a garage at home and an assigned parking spot at work). In such embodiments, parking assist mode can be entered whenever the vehicle approaches any of the desired parking locations. When in parking assist mode, system 102 can (for example) switch from displaying map imagery on display 112 to displaying imagery from one or more cameras 116 (such as the front facing camera, the back-up camera, or an external camera), together with one or more visual representations of the proximity to the desire parking location, as discussed in greater detail below.

Processing then proceeds to a step 1404, where a reference image is determined. If the system only has a single reference image, then this step simply selects that reference image. Otherwise, the best reference image (i.e., the reference image the will provide the best matching with the current image) is selected. For example, the reference image with the closest relative lighting time to the current relative lighting time may be selected. Thus, for example, if the system has two reference images with relative lighting times of 2 hours after sunrise and 3 hours until sunset and the current relative lighting time is 4 hours after sunrise, then the reference image with the relative image time of 2 hours after sunrise might be chosen. Other ways of measuring the relative lighting time can similarly choose a reference image with the closest relative lighting to the current lighting conditions. Alternatively the vanishing point of the reference image (alone or in combination with the vanishing point of a current comparison image) may be used to select the reference image. In still another embodiment, other data associated with the reference image (for example, data captured from a sensor of sensor array 108) may be used to select the reference image. Other techniques for selecting a best reference image are also contemplated.

Next, at step 1406, camera 116 captures a comparison image. As described above, the comparison image can be captured with any of the available cameras. For the best match, the same camera used to capture the reference image can be used. In some embodiments, the comparison image may be preprocessed to match an orientation of the reference image. In other embodiments, the reference image may adjusted to match the orientation of the comparison image. As described above, the orientation of the reference image may be stored with the reference image, or reference images may be converted to a standard orientation when they are initially captured. The comparison image can be skewed and rotated similarly to the reference image to match the orientation and provide for the best feature matching, or vice versa.

Processing then proceeds to a step 1408, where the proximity of the vehicle to the desired parking location is determined by comparing the comparison image to the reference image. As described above with respect to FIGS. 10, 11A and 11B, proximity detection can be performed by first detecting features in the reference image and the comparison image, matching the detected features to determine a set of coherent points, filtering the coherent points to eliminate mismatched features and measuring an average distance between the each pair of coherent points to determine a relative proximity. For example, the convergence of the coherent points can be measured to determine proximity. Other ways of determining the proximity on the basis of the reference image and the comparison images are also contemplated. In addition to determining a proximity, a trajectory may also be calculated. For example, if the x differences between coherent points on left quarter of the images are generally positive and the x difference on the right three quarters of the images are generally negative, it may indicate that the current trajectory of the vehicle is too far to the right. If this trajectory is constant, it may indicate that the vehicle is driving straight forward with a horizontal offset to the right. If instead, the trajectory is moving to the left, it may indicate that the vehicle is not moving straight forward, but instead is angled to one side. Any or all of this information can be communicated to the user via the display as described above with respect to FIGS. 11A and 12 and described below.

Next, processing continues to step 1410, where the visual proximity indicator is displayed to the user on display 112. Broadly, the visual proximity indicator is any visual representation that indicates to the user how the vehicle should be maneuvered to reach the desired parking location. Exemplary visual proximity indicators are depicted in FIGS. 11A and 12. Visual proximity indicators may include representations of a trajectory, a proximity, one or more identified features, one or more convergence lines for the identified features and/or any other information useful to the driver. In some embodiments, the visual proximity indicator is superimposed on display 112 over the current comparison image. In other embodiments, the visual proximity indicator can be superimposed over whatever is displayed on display 112, without displaying the current comparison image. In still other embodiments, the visual proximity indicator is displayed alone on the display without any other elements.

Alternative visual indicators may include lines, dots, or arrows that align as the vehicle approaches the desired parking location or icons that change color or size as the vehicle approaches the desired parking location. In some embodiments, text may be displayed on display 112 as a visual indicator. Such text might include a distance remaining, a count down, or a description of the proximity (e.g., “almost there”). In some embodiments, non-visual representations of the proximity may be provided to the use in addition or instead. For example, the system could beep with increasing frequency as the vehicle approaches the desired parking location, or haptic feedback could be provided (e.g., via the steering wheel) when the vehicle has arrived at the desired parking location.

Processing then proceeds to decision 1412, where it is determined whether the vehicle is stopped. In some embodiments, this decision is made by comparing the current comparison image to one or more previous comparison images. In some embodiments, decision 1412 occurs in parallel with steps 1404 through 1410 and may interrupt those steps if it is determined that the vehicle is stopped. If a series of identical or near identical comparison images have been captured by camera 116, this may indicate that the vehicle is no longer moving. In other embodiments, this decision is made based on data from one or more sensors in sensor array 108 such as accelerometers, gyroscopes, magnetometers, and/or inertial sensors. In still other embodiments, this decision may be made based on changes in location as measured by location determining component 114. If the vehicle is stopped, processing proceeds to step 1414; otherwise, processing returns to step 1406 and steps 1406 through 1412 are repeated. Thus, as the vehicle moves towards the desired parking location, the comparison image can be continuously updated. For example, the comparison image could be captured (and the other steps repeated) once a second, five times a second, approximately thirty times a second, or at any other rate. In some embodiments, these steps may be repeated as quickly as the system can capture and process new comparison images. In other embodiments, the steps are capped at a maximum update rate. Alternatively, if the vehicle is stopped, the user may instead be prompted to continue in parking assist mode or to exit parking assist mode.

Finally, at step 1414, the system exits parking assist mode. In some embodiments, the system may automatically proceed to step 1414 when the vehicle arrives at the desired parking location without waiting for the vehicle to stop. In some embodiments, the system may automatically cause camera 116 to capture an updated reference image when it exits parking assist mode. In other embodiments, the system may only capture an updated reference image if the vehicle is determined to have arrived at the desired parking location. In any of these embodiments, the system may only capture an updated reference image if the relative lighting time is sufficiently far from the relative lighting time of the closest existing reference image. In still other embodiments, the system may prompt the user to capture a new reference image if the vehicle stops without reaching the desired parking location.

In configurations, once system 102 determines that the driver has reached the ideal spot based on the above comparisons, it may power down or enter a low-power or suspended state to conserve battery power. This may be automatic, or it may generate a prompt with which the user may interact (e.g., “The device will now power down in X seconds. Click here to cancel shutdown.”).

Although systems and methods for assisting a user with parking in a desired parking location have been disclosed in terms of specific structural features and acts, it is to be understood that the appended claims are not to be limited to the specific features and acts described. Rather, the specific features and acts are disclosed as exemplary forms of implementing the claimed devices and techniques. Furthermore, although methods have been described serially, certain steps may be undertaken concurrently or in alternative orders without departing from the scope of the invention.

1. A system for assisting a user in parking a vehicle, comprising:
a camera;
a location determining component;
a display;
a processor; and
one or more computer-readable media storing computer-executable instructions that, when executed by the processor, assist the user in parking the vehicle by:
capturing, using the camera, a registration image when the vehicle is in a first parking location;
capturing, using the location determining component, a geographic location of the system when the vehicle is in the first parking location;
subsequently determining, using the location determining component, that the vehicle is within a predetermined distance of the geographic location;
in response to determining that the vehicle is within the predetermined distance of the geographic location, causing the system to enter a parking assist mode comprising:
capturing, using the camera, a comparison image;
determining a proximity of the vehicle to the first parking location by comparing the comparison image to the registration image; and
displaying, on the display, a visual representation of the proximity.

2. The system of claim 1, wherein, the comparison image is displayed together with the visual representation of the proximity

3. The system of claim 1, wherein the registration image is one of a plurality of registration images, and wherein the registration image is selected from the plurality of registration images based on one of a current time since sunrise and a current time until sunset.

4. The system of claim 1, wherein the visual representation of the proximity includes a color-coded path for the vehicle.

5. The system of claim 1, wherein the visual representation of the proximity includes a projected parking location and the first parking location.

6. The system of claim 1, wherein comparing the comparison image to the registration image includes:
determining an orientation of the camera when capturing the comparison image; and
preprocessing the comparison image to match an orientation of the camera when capturing the registration image.

7. The system of claim 1, wherein determining the proximity of the vehicle to the first parking location is performed by determining convergence of a plurality of features common to the comparison image and the registration image.

8. A system for assisting a user in parking a vehicle in a first parking location, comprising:
a camera;
a location determining component;
a display;
a processor; and
one or more computer-readable media storing computer-executable instructions that, when executed by the processor, assist the user in parking the vehicle by:
determining, using the location determining component, that the vehicle is within a predetermined distance of the first parking location;
determining, based on one of a time since sunrise and a time until sunset, a registration image of a plurality of registration images;
capturing, using the camera, a comparison image;
determining a proximity of the vehicle to the first parking location by measuring convergence of a plurality of features common to the comparison image and the registration image;
displaying a visual representation of the proximity of the vehicle to the first parking location on the display.

9. The system of claim 8, wherein the capturing of the comparison image, the determining of the proximity, and the displaying of the visual representation are repeated until the vehicle arrives at the first parking location.

10. The system of claim 8, wherein the visual representation of the proximity includes a color-coded path for the vehicle.

11. The system of claim 8, wherein the visual representation of the proximity includes a projected parking location and the first parking location.

12. The system of claim 8, wherein comparing the comparison image to the registration image includes:
determining an orientation of the camera when capturing the comparison image; and
preprocessing the comparison image to match an orientation of the camera when capturing the registration image.

13. The system of claim 8, wherein the computer-readable media further stores computer-executable instructions that, when executed by the processor, capture an additional registration image when the vehicle arrives at the first parking location.

14. The system of claim 8, wherein the system is a personal navigation device.

15. A method of assisting a user in parking a vehicle, comprising:
capturing, using a camera associated with a portable device in the vehicle, a registration image when the vehicle is in a first parking location;
capturing, using a location determining component of the portable device in the vehicle, a geographic location of the portable device when the vehicle is in the first parking location;
subsequently determining, using the location determining component of the portable device in the vehicle, that the vehicle is within a predetermined distance of the geographic location;
in response to determining that the vehicle is within the predetermined distance of the geographic location, causing the portable device to enter a parking assist mode comprising:
capturing, using the camera associated with the portable device, a comparison image;
determining a proximity of the vehicle to the first parking location by comparing the comparison image to the registration image; and
displaying, on a display associated with the portable device, a visual representation of the proximity.

16. The method of claim 15, wherein the capturing of the comparison image, the determining of the proximity, and the displaying of the visual representation are repeated until the vehicle arrives at the first parking location.

17. The method of claim 15, wherein the registration image is one of a plurality of registration images, and wherein the registration image is selected from the plurality of registration images based on one of a current time since sunrise and a current time until sunset.

18. The method of claim 15, wherein the visual representation of the proximity includes a color-coded path for the vehicle.

19. The method of claim 15, further comprising capturing an additional registration when the vehicle arrives at the first parking location.

20. The method of claim 15, wherein determining the proximity of the vehicle to the first parking location is performed by determining convergence of a plurality of features common to the comparison image and the registration image.
